(19) United States
(12) Patent Application Publication
(10) Pub. No.: US 2011/0066484 A1
(43) Pub. Date: Mar. 17, 2011

(54) ON-LINE ADVERTISEMENT OUTPUT CONTROLLING SYSTEM AND METHOD OF THE SAME

(75) Inventors: Ji-hyuk Cha, Seoul (KR); Ki-won Nam, Seoul (KR)

(73) Assignee: Golconda Co., Ltd.

(21) Appl. No.: 12/438,544

(22) PCT Filed: Aug. 21, 2007
(86) PCT No.: PCT/KR2007/003977

§ 371 Date: Aug. 17, 2010

(30) Foreign Application Priority Data
Aug. 21, 2006 (KR) 10-2006-0078997
Dec. 14, 2006 (KR) 10-2006-0128147

(51) Int. Cl. G06Q 30/00

(52) U.S. Cl. 705/14.23; 705/14.39

(57) ABSTRACT

An online advertisement output control system and method are provided, which can increase attention on advertisement information outputted on the screen of the user browser. According to the online advertisement output control system and method of the invention, it is possible to increase attention on advertisements from users by increasing accumulated integrated rewards through cross-marketing, activate the sale of a corresponding product by offering an additional discount benefit to individual users through brand icons, allow users to use online accumulated integrated points in offline as well, increase attention on advertisements by embedding star information, and get more attention on advertisements by allowing users to take part in determination and modification regarding the matching of an article and an embedded advertisement.

### TECHNICAL FIELD

The present invention relates to an online advertisement output control system and method, and more particularly, to an online advertisement output control system and method, which can output corresponding companies in the higher ranks of a result list by allowing at least two companies to form an alliance for cross-marketing in order to increase the amount of integrated rewards outputted on the screen of a user browser so that the integrated rewards of the corresponding companies saved in an integrated manner upon clicking on advertisements and product information may be added up and outputted to the screen, and which can increase attention on advertisements or sites from users and activate the output of online advertisement information by outputting stars' image information and moving image information to the screen along with the display of accumulated amounts for each site outputted as each search result.

### BACKGROUND ART

An advertising technique or a shopping activation technique is a typical method of offering rewards to customers. In other words, they are methods in which, when a certain customer views an advertisement or purchases a product, a predetermined reward appropriate to that behavior is offered to the corresponding customer to get more advertisement clicks and encourage them to purchase more products.

In such a conventional technique, a method of offering rewards to customers upon viewing an advertisement or on a product purchase is a method in which fixed marketing costs are shared and given to a plurality of customers who have viewed advertisements or purchased products.

Therefore, such a conventional technique has the drawback that individual customers cannot feel any particular merit since rewards to be given are very small, and thus this technique is of little help to sellers' marketing through advertisements or shopping activation.

Moreover, unlike advertising, no particular rewards are given in case of viewing product information in order to purchase a product. Thus, if someone is not an actual purchaser, this technique is very stingy even to a behavior of viewing product information, and hence the basis for shopping activation cannot be provided.

Accordingly, in order to solve these problems, the present applicant filed patent applications (Korean Patent Application NOs. 10-2006-45900 and 10-2006-88063), entitled “member-integrated rewards point offering system and method of offering the same”, which can motivate advertisement viewing and achieve shopping activation in a manner that rewards awarded upon a plurality of customers' viewing advertisements are accumulated in real time by integrated processing, and when a certain customer generates a purchase signal, integrated rewards earned jointly by a plurality of members are offered as the discount rate of a purchase price for the corresponding customer.

The “member-integrated rewards point offering system and method of offering the same” filed by this applicant is a system and method in which, when a certain customer generates a product purchase signal, a price discount for the corresponding product is offered to bring about a large benefit directly to the purchasing member by using all the member-integrated reward points saved until before that point of time, in a manner of using the member integrated reward points saved by integrating altogether the points for each member awarded as rewards for advertisements and product information viewed by a plurality of customers.

However, the patent application of the present applicant on the conventional “member-integrated rewards point offering system and method of offering the same” is problematic in that it is a technique of offering an epoch-making rewards system from the standpoint of sellers and consumers of online auction companies, shopping malls, open markets, etc., but its merit is not relatively great from the standpoint of advertisers.

In other words, as advertisement information is outputted by a lot of members clicking on sites or advertisements with a higher amount of rewards, sites or advertisements with a relatively smaller accumulated amount show a low advertisement output rate of members.

Further, the conventional “member-integrated rewards point offering system and method of offering the same” is problematic in that it is hard to introduce differentiated target advertising because accumulated amounts cannot be differentially saved according to each user's personal information, for example, by users' age, area, and gender.

Additionally, the convention “member-integrated rewards point offering system and method of offering the same” has the problem that the size of payment for advertising costs may have nothing to do with an increase of sales at all because it is a system that only collects per-click advertising costs for users' advertisement information regardless of the sales of a corresponding advertiser's shopping mall or shopping site that has been newly issued from a corresponding advertisement upon settlement of advertising costs with the advertiser. That is to say, conventionally, there has been no consideration for poor sales at all in the settlement of advertising costs.

Moreover, online advertisement information is basically for outputting corresponding advertisement information to more users through more user clicks. Thus, the conventional “member-integrated rewards point offering system and method of offering the same” has the problem that although it has its own effect of outputting accumulated integrated rewards of members to each site information outputted as a search result, there is a limitation in increasing attention from users who are not particularly interested in accumulated integrated rewards.

Meanwhile, existing online advertising companies, such as “Google”, provide an online advertising tool called AdSense that outputs advertisements in the middle of text files like news articles and outputs advertisement information related to the corresponding keyword by using a repeated keyword of the text. However, such Google's advertising turned out to have provided an ironic advertisement, in which a text saying that a chopped body was delivered by a famous brand bag was analyzed from the article about a torso murder to output the advertisement of the corresponding famous brand in the middle of the text. Accordingly, there is an urgent need to develop an advertising system for increasing attention from users while solving these problems of online advertising.

Besides, at present, shopping malls provide “reviews” for each shopping item, and users who have viewed the reviews tend to positively use the reviews in the purchase of the corresponding product. Hence, passive rewarding is being performed at present, including choosing multiple users who have registered reviews by lot and offering them specific premiums. However, there is a difficulty in encouraging user to write more reviews and activating the sale of products by this passive rewarding. This is because users generally do not put up reviews to get premiums which are unlikely to win. For this reason, it is often the case that, in reality, only users who are very satisfied or disappointed compared to the phrase “satisfaction relative to price” write reviews mainly as means of praising or complaining about their own products. Therefore, the reviews cannot reflect well the opinions of most of the users who purchased a corresponding product.

### Disclosure

### Technical Problem

It is an object of the present invention to provide an online advertisement output control system and method, which can output corresponding companies in the higher ranks of a result list by allowing at least two companies to form an alliance for cross-marketing in order to increase the amount of integrated rewards outputted on the screen of a user browser so that the integrated rewards of the corresponding companies saved in an integrated manner upon clicking on advertisements and product information may be added up and outputted to the screen.

It is another object of the present invention to provide an online advertisement output control system and method, which can induce the activation of advertisement output and the activation of shopping by offering users discount icons, by company, of companies outputted as a result of keyword search advertising and notifying users of the existence of discount icons on the screen upon searching.

It is another object of the present invention to provide an online advertisement output control system and method, which enables target advertising by offering a reward amount or discount amount differentiated according to personal information, i.e., by user's age, area, and gender.

It is another object of the present invention to provide an online advertisement output control system and method, which can increase attention on advertisements or sites from users and activate the output of online advertisement information by outputting stars' image information and moving image information to the screen along with the display of accumulated amounts for each site outputted as each search result.

It is another object of the present invention to provide an online advertisement output control system and method, which can achieve the correct classification and matching of advertisements by allowing users to take part in setting the advertisement category and ad title of a site or ad information outputted as a result of keyword search of a portal site and generating a correction signal for the site or ad where the category is wrongly classified.

It is another object of the present invention to provide an online advertisement output control system and method, which can achieve advertisement matching with a news article or text by allowing users to determine and set, regarding advertisements posted in a variety of text files provided in news articles or blogs provided by a portal site, whether the content of a corresponding news article or text file matches with that of an advertisement, and generating a correction signal for a wrongly matched advertisement.

It is another object of the present invention to provide an online advertisement output control system and method, which can allow a purchaser to easily check reviews by linking the URL of a personal blog with a review of a specific product posted therein and the URL of a sales site, and offering a predetermined portion of the purchase price or advertising cost to the owner of the personal blog with the corresponding review posted therein when a purchaser having viewed the review purchase the corresponding product.

It is another object of the present invention to provide an online advertisement output control system and method, which can induce the participation of an advertiser in a re-auction by performing a real-time re-auction for each company that has used up a prepaid amount of advertising upon an auction of advertising amounts by rank order for keyword search results so that per-click fees upon a re-auction may vary regardless of the auction of per-click fees at the initial stage.

### Technical Solution

In accordance with the present invention, there is provided an online advertisement output control system, comprising: user PCs having a communication module, such as a modem, and a browser embedded therein so as to access the main screen of a shopping mall or search portal and click on a search result through searching for shopping or through searching of specific information, to output corresponding search result information on the screen; advertiser terminals which provide advertising costs for each advertiser or each sales product of an advertiser, set a desired site or product advertising data in an online advertisement output control server, generate a request signal for cross-marketing with a specific advertiser designated by the corresponding advertiser, and issue a permission signal therefor, to perform the request and permission of cross-marketing for accumulated reward amounts between at least two advertisers and the viewing and registration of advertisement information; a shopping mall server which uploads advertisement information to the online advertisement output control server, sets upper limit information on advertising payment costs, and receives advertising costs settlement information; a search portal server which posts integrated rewards information provided from the online advertisement output control server and integrated rewards information added up upon cross-marketing in respective sites built in a search engine, and posts advertisement information therein, to transmit a click signal thereof to the online advertisement output control server; and the online advertisement output control server which processes the settlement of per-click advertising costs for advertisement information registered by a corresponding advertiser in real time, calculates accumulated integrated rewards by advertiser site or product category, displays the calculated accumulated integrated rewards on the screen of the shopping mall or search portal, and controls an advertisement screen and rewards information so as to receive a signal for cross-marketing between specific companies and a permission signal, add up the accumulated rewards of the corresponding company and output them on the screen.

Preferably, in the online advertisement output control system, the online advertisement output control server is a server which induces users to access all sites evenly by performing a separate display indicating the provision of accumulated integrated rewards for each advertising site information on the screens of shopping mall sites and search portal sites and keeping specific accumulated integrated amounts of rewards from being displayed while displaying accumulated integrated amounts of rewards for each site if each of corresponding advertising sites is clicked in order to prevent users' access and shopping from being concentrated only in sites with high accumulated integrated rewards and induce even users' access.

### ADVANTAGEOUS EFFECTS

As described above and will be discussed below, the online advertisement output control system and method in accordance with the present invention can increase attention on advertisements from users by increasing accumulated integrated rewards through cross-marketing, activate the sale of a corresponding product by offering an additional discount benefit to individual users through brand icons, allow users to use online accumulated integrated points in offline as well, increase attention on advertisements by embedding star information, and get more attention on advertisements by allowing users to take part in determination and modification regarding the matching of an article and an embedded ad.

### DESCRIPTION OF DRAWINGS

The above and other objects and features of the present invention will become apparent from the following description of the preferred embodiments given in conjunction with the accompanying drawings, in which:

FIG. 1 is a block diagram showing a schematic configuration of an online advertisement output control system in accordance with a first embodiment of the present invention;

FIGS. 2 and 3 are views illustrating a search result window processed through the online advertisement output control system in accordance with the first embodiment of the present invention and the breakdown of the settlement of advertising costs depending on the sale of products by each site, respectively;

FIG. 4 is a block diagram showing the configuration of an online advertisement output control server in accordance with the first embodiment of the present invention;

FIGS. 5, 6, 7, and 8 are flowcharts showing a signal flow of the online advertisement output control system in accordance with the first embodiment of the present invention;

FIGS. 9, 10, and 11 are views showing brand icon output screens of the online advertisement output control system in accordance with the first embodiment of the present invention;

FIGS. 12, 13, and 14 are flowcharts showing a brand icon processing status through the online advertisement output control system in accordance with the first embodiment of the present invention;

FIG. 15 is a block diagram showing the configuration of a system for executing offline rewards processing working in conjunction with the online advertisement output control system in accordance with the first embodiment of the present invention;

FIG. 16 is a flow chart showing a signal flow through the system of FIG. 15;

FIG. 17 is a block diagram showing the configuration of an online advertisement output control system in accordance with a second embodiment of the present invention;

FIGS. 18, 19, and 20 are views showing a star information posting state through the online advertisement output control system in accordance with the second embodiment of the present invention;

FIGS. 21, 22, and 23 are flowcharts showing a signal flow of the online advertisement output control system in accordance with the second embodiment of the present invention;

FIG. 24 is a block diagram showing the configuration of an online advertisement output control system in accordance with a third embodiment of the present invention;

FIGS. 25 and 26 are views showing a state of posting an advertisement in an article through the online advertisement output control system in accordance with the third embodiment of the present invention; and

FIGS. 27 and 28 are flowcharts showing a signal flow of the online advertisement output control system in accordance with the third embodiment of the present invention.

### BEST MODE FOR THE INVENTION

Hereinafter, an online advertisement output control system in accordance with a first embodiment of the present invention will be described in detail with reference to the accompanying drawings.

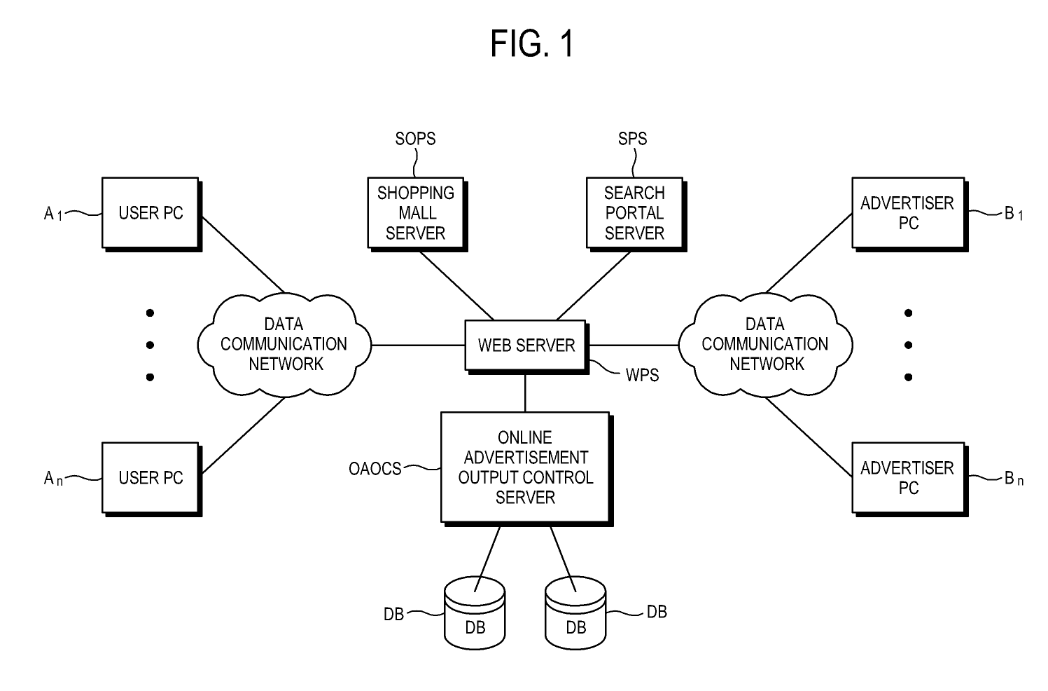

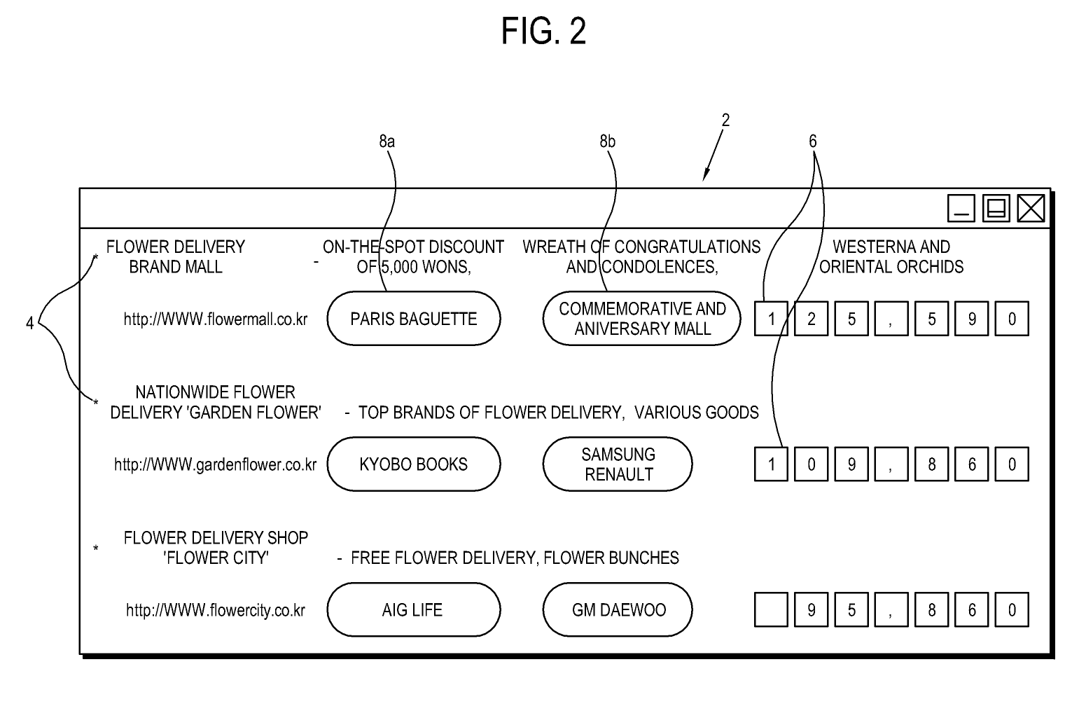

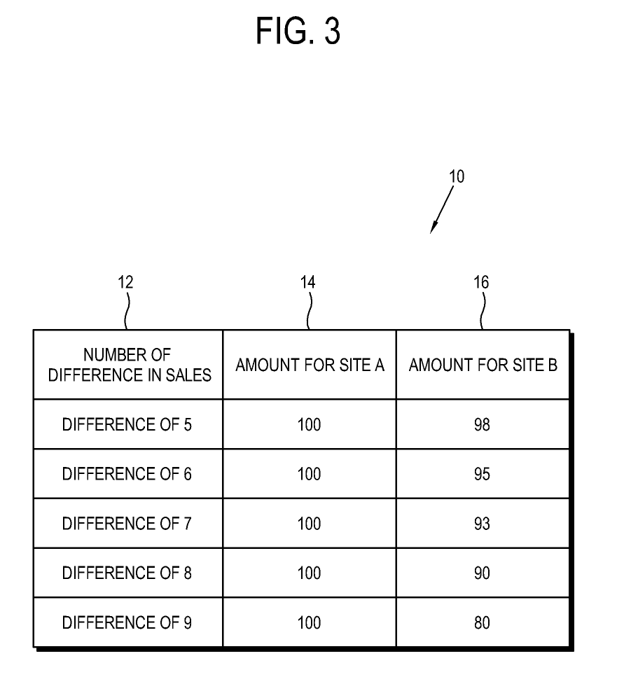

FIG. 1 is a block diagram showing a schematic configuration of an online advertisement output control system in accordance with a first embodiment of the present invention. And, FIGS. 2 and 3 are views showing a search result window processed through the online advertisement output control system in accordance with the first embodiment of the present invention and the breakdown of the settlement of advertising costs depending on the sale of products for each site, respectively.

Referring to the drawings, the online advertisement output control system in accordance with the first embodiment of the present invention can output corresponding companies in the higher ranks of a result list by allowing at least two companies to form an alliance for cross-marketing in order to increase the amount of integrated rewards outputted on the screen of a user browser so that the integrated rewards of the corresponding companies saved in an integrated manner upon clicking on advertisements and product information may be added up and outputted to the screen

In other words, the online advertisement output control system in accordance with the first embodiment of the present invention offers a discount amount to a user purchasing a product by integrating, by category or site, rewards offered to individual users upon the users' searching or shopping. Therefore, it is apparent that the sale of more products is done in sites where more accumulated integrated rewards are saved. Accordingly, the online advertisement output control system in accordance with the first embodiment of the present invention enables access by more users by allowing companies with small accumulated integrated rewards to form an alliance and adding up and outputting the integrated rewards accumulated for each site.

In another example, the online advertisement output control system in accordance with the first embodiment of the present invention is a system which induces users to access all sites evenly by performing a separate display indicating the provision of accumulated integrated rewards for each advertising site information on the screens of shopping mall sites and search portal sites and keeping specific accumulated integrated amounts of rewards from being displayed while displaying accumulated integrated amounts of rewards for each site if each of corresponding advertising sites is clicked in order to prevent users' access and shopping from being concentrated only in sites with high accumulated integrated rewards and induce even users' access.

Meanwhile, the online advertisement output control system in accordance with the first embodiment of the present invention is a system which can induce the activation of advertisement output and the activation of shopping by offering users discount icons, by company, of companies outputted as a result of keyword search advertising and notifying users of the existence of discount icons on the screen upon searching.

In other words, the online advertisement output control system in accordance with the first embodiment of the present invention is a system which can promote the activation of online advertising and hence the activation of shopping by offering discount icons or integrated accumulated amount icons for discount on the sides of information of the companies whose advertisement information is outputted through keyword search in a search portal or a shopping mall site and providing access to the main screen of the corresponding site by clicking on the corresponding icons to thus display a specific discount amount or an integrated accumulated discount amount.

Meanwhile, the online advertisement output control system in accordance with the first embodiment of the present invention is a system which enables target advertising by offering a reward amount or discount amount differentiated according to personal information, i.e., by user's age, area, and gender.

In other words, the online advertisement output control system in accordance with the first embodiment of the present invention is a system which offers a more discount amount or accumulated reward amount upon outputting corresponding advertisement information to users falling within the range of target age, area, or gender of the corresponding advertised item according to the advertiser's intention because the users have a higher probability of shopping.

For this, the online advertisement output control system in accordance with the first embodiment of the present invention provides user PCs A1˜An having a communication module, such as a modem, and a browser stored therein so as to access the main screen of a shopping mall or search portal and clicking on a search result through searching for shopping or through searching of specific information, thus outputting a corresponding search result information on the screen.

There are provided advertiser terminals B1˜Bn which provide advertising costs for each advertiser or each product of an advertiser, set a desired site or product advertising data in an online advertisement output control server OAOCS while providing advertising costs to be paid by advertising company and by sales product of advertising companies, issue a request signal for cross-marketing with a specific advertising company designated by the corresponding advertising company, and issue a permission signal therefor, thus performing the request and permission of cross-marketing for accumulated reward amounts between at least two advertising companies and the viewing and registration of advertisement information.

The online advertisement output control server OAOCS processes the settlement of per-click advertising costs for advertisement information registered by a corresponding advertising company in real time, calculates accumulated integrated rewards by advertiser site or product category, displays the calculated accumulated integrated rewards on the screen of a shopping mall or search portal, and controls an advertisement screen and rewards information so as to receive a signal of cross-marketing between specific companies and a permission signal, add up the accumulated rewards of the corresponding company and output them on the screen.

Furthermore, the online advertisement output control system in accordance with the first embodiment of the present invention provides user PCs A1˜An which access to a variety of websites, such as shopping malls, search portals, respective e-commerce malls, personal blogs, etc., having advertisement information and product information posted therein to output the corresponding advertisement information on the screen, and a shopping mall server SOPS and a search portal server SPS which are linked to the online advertisement output control server OAOCS to upload advertisement information to the online advertisement output control server OAOCS, register cross-marketing advertisement information, and receive advertising costs settlement information.

For example, when a specific search keyword (i.e., flower delivery) is entered in the search window (not shown) of the main screen of a search portal by using the online advertisement output control system in accordance with the first embodiment of the present invention, a search result window 2 as shown in FIG. 2 is outputted.

In the online advertisement output control system in accordance with the first embodiment of the present invention, the online advertisement output control server OAOCS and the search portal server SPC operate in conjunction with each other, and hence the online advertisement output control server OAOCS outputs accumulated rewards information 6 of corresponding search result site information 4 in the search result outputted from the search portal server SPS.

Moreover, the online advertisement output control server OAOCS outputs information 8a and 8b on affiliate companies indicating that the marketing of corresponding advertisement output is a way of cross-marketing on the screen at the sides of the search result site information 4.

In other words, with information of pre-registered advertising companies and cross-marketing information between the advertising companies stored in the online advertisement output control server OAOCS, if search result information of the search portal server SPS is a site or product of any one of the advertising companies having the corresponding cross-marketing information registered, the online advertisement output control server OAOCS outputs information of the advertising companies that have performed the registration of cross-marketing and the total accumulated integrated rewards of the corresponding advertising companies on the screen.

Therefore, the online advertisement output control system in accordance with the first embodiment of the present invention can output the total accumulated integrated rewards information of the cross-marketing partners on the screen in order for the advertisers to overcome the limitation of the system in which results of search are outputted in the order of accumulated integrated rewards, output corresponding advertisement information and site information in relatively higher ranks because the rank of output is determined by the total accumulated integrated rewards, to thus increase the click rate or shopping purchase rate of a user, and increase the output frequency because, when the site or advertisement information of one of the companies registered by cross-marketing is outputted, the site information or advertisement information of the other affiliate companies is also outputted.

Meanwhile, the online advertisement output control system in accordance with the first embodiment of the present invention has the problem that although the above-described effects can be achieved by the above-described advertising method through cross-marketing, when information on at least two companies or products is outputted through cross-marketing, only the products of a particular company may continue to be sold while paying the same advertising costs.

Accordingly, the online advertisement output control system in accordance with the first embodiment of the present invention performs the settlement of advertising costs of a company performing cross-marketing in such a manner as to pay different advertising costs of each of the affiliate companies performing cross marketing depending on the difference in the number of product sales via the corresponding site as shown in FIG. 3.

For this purpose, the online advertisement output control server OAOCS determines whether or not product sales is being conducted through product advertisement or site advertisement posted by the advertiser, in the state that it communicates with the shopping mall server SOPS or the search portal server SPS. That is, information on product sales is transmitted from the shopping mall server SOPS or the search portal server SPS, and an advertising company server (not shown), to the online advertisement output control server OAOCS, and the online advertisement output control server OAOCS accumulates the corresponding information and differentially processes advertising costs depending on the difference in the number of product sales for each company performing cross-marketing.

For example, if it is assumed that there are two companies, A and B, which formed an alliance for cross-marketing and the per-click advertising cost for each company is 100 wons (Korean currency), and company A make ten product sales while company B make five product sales, the per-click advertising cost due from company A is 100 wons and the per-click advertising cost due from company B is 98 wons because the difference in the number of product sales between company A and company B is five. Such table data is preferably set in the online advertisement output control server OAOCS before the registration of alliance for cross-marketing.

Therefore, the online advertisement output control server OAOCS compensates for the difference in sales, upon settlement of advertising costs, which may be caused by cross-marketing while monitoring the sales performance of each of the advertisers.

Meanwhile, in contrary to the provision of accumulated integrated rewards information for each site in a search result information of a shopping mall or a search portal, although there is not shown, the online advertisement output control system in accordance with the first embodiment of the present invention is able to display a separate phrase saying that accumulated integrated rewards will be displayed, upon clicking, in the corresponding search result information without providing separate accumulated integrated rewards information in the search result information.

That is, when a certain user clicks on search result information outputted in a specific rank while viewing the search result information, accumulated integrated rewards information provided by the site outputted as the corresponding search result information is outputted. This method enables accumulated integrated rewards to be processed as a hidden value regardless of an individual site advertisement or a cross-marketing site advertisement, and keeps even a site with a small amount of accumulated integrated rewards from being disadvantaged.

Therefore, the online advertisement output control server OAOCS performs update calculation of accumulated integrated rewards for each advertising site, and with the corresponding accumulated integrated rewards information processed as a hidden value, transmits the corresponding accumulated integrated rewards information so as to be displayed on the screen of the corresponding shopping mall or search portal according to whether a user's click signal is applied or not.

Referring to FIG. 2, in the online advertisement output control system in accordance with the first embodiment of the present invention, the online advertisement output control server OAOCS and the search portal server SPS work in conjunction with each other, and the online advertisement output control server OAOCS calculates an accumulated reward amount accumulated in the site information 4 of a corresponding search result outputted from the search portal server SPS and processes the accumulated reward amount information as a hidden value. Hence, the accumulated reward amount information is not outputted to the screen.

Additionally, the online advertisement output control server OAOCS outputs information 8a and 8b on affiliate companies indicating that the marketing of corresponding advertisement output is a way of cross-marketing on the screen at the sides of the search result site information 4. At this time, if it is not cross-marketing, the information 8a and 8b on additional affiliate companies is not outputted in the corresponding search result site information 4.

At this time, the online advertisement output control server OAOCS determines whether a click signal on the search result site information 4 is applied from the user PCs A1˜An. If a click signal on specific search result site information 4 is applied, accumulated rewards information accumulated in conjunction with the corresponding search result site information 4 is outputted on the output screen 2 so that the user can be aware of how much the accumulated reward amount of the corresponding site is.

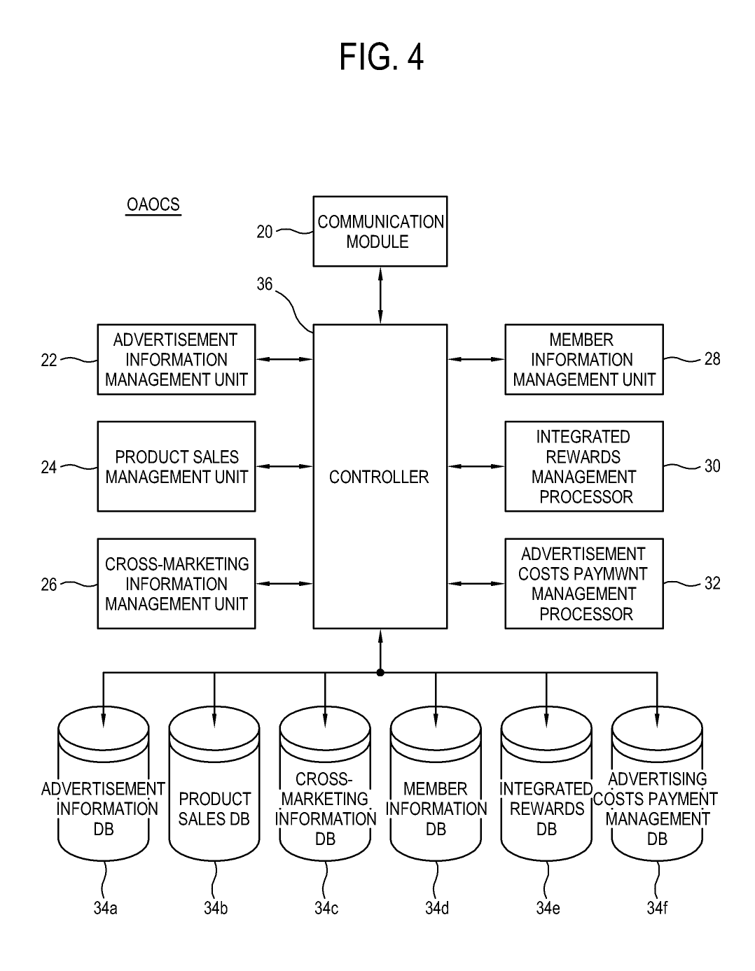

FIG. 4 is a block diagram showing the configuration of the online advertisement output control server in accordance with the first embodiment of the present invention.

Referring to this drawing, the online advertisement output control server OAOCS performs the settlement of per-click advertising costs, the management of output of integrated point accumulation information and maximum discountable amount information for each product, the processing of discounted costs upon a product purchase, the overall advertising-related processing and discount information processing of cross-marketing (marketing using the total accumulated integrated rewards) of multiple advertising companies, and the processing of discounted costs, in communication with a shopping mall server SOPS, a search portal server SPS, and advertiser PCs B1˜Bn.

Accordingly, the online advertisement output control server OAOCS is comprised of a communication module, an advertisement information management unit, a product information (sales) management unit, a cross-marketing information management unit 26, a member information management unit, an integrated rewards management processor, an advertising costs payment management processor, an advertisement information DB, a product information (sales) DB, a cross-marketing information DB, a member information DB, an integrated rewards DB, an advertising costs payment management DB, and a controller.

Reference numeral 20 indicates a communication module having a modem means in order to receive advertisement information and product information from advertiser PCs B1˜Bn, a plurality of seller servers (not shown) to post them on the web pages of a shopping mall server SOPS and a search portal server SPS, receive advertisement information and product information view signals from the user computer terminals A1˜An, post integrated point accumulation information and discount information in the shopping mall server SOPS, and transmit and receives cross-marketing information from each advertising company or advertiser.

Reference numeral 22 indicates an advertisement information management unit which uploads and posts advertisement information provided from the first to N-th advertiser PCs B1˜Bn and checks and manages a user's screen output state of the corresponding advertisement information.

Reference numeral 24 indicates a product information (sales) management unit which uploads and posts product information provided from the shopping mall server SOPS, checks and manages a user's screen output state of the corresponding product information, posts discount rate information for each product depending on advertising costs, and performs settlement by applying the availability of products upon settlement of per-click advertising costs.

Reference numeral 26 indicates a cross-marketing management unit which receives a request signal for cross-marketing from one of the first to N-th advertiser PCs B1˜Bn, transmits the corresponding signal to the advertising company or advertiser PCs B1˜Bn designated by the corresponding advertiser, and manages information for performing cross-marketing processing depending on permission.

Reference numeral 28 indicates a member information management unit which manages member information, such as a member's gender, age, area, etc., so as to enable the target advertising for each member, the accumulation management of advertisement information-per-click integrated points, and the management of per-click advertising costs to be paid, by member, and manages information of a plurality of shopping mall companies and search portal companies. Reference numeral 30 indicates an integrated rewards management processor which receives advertisement information and product information view signals from a plurality of customer computer terminals A1˜An to update member-integrated rewards information, gives the corresponding member-integrated rewards according to a product purchase signal transmitted from one of the customer computer terminals A1˜An to use up the corresponding integrated rewards, and accumulates the total rewards of advertisement information crossed according to the application of the cross-marketing to the corresponding advertisement information.

Reference numeral 32 indicates an advertising costs payment management processor which charges, in advance, a predetermined amount of advertising costs to be paid for the output of advertisement information outputted to the main screen of the homepage of a plurality of shopping mall companies and search portal companies, gives parts of the advertising costs to a purchasing member at a discount amount upon purchase of a product of a corresponding advertising company in proportion to the charged advertising costs to be paid, and processes the accumulative calculation of corresponding advertising costs even upon clicking on the advertising company linked according to whether cross-marketing is applied or not.

Reference numeral 34a indicates an advertisement information DB for storing advertisement information provided from the first to N-th advertiser PCs B1˜Bn, and reference numeral 34b indicates a product (sales) information DB for storing sales product information of a corresponding advertising company provided from the first to N-th advertiser PCs B1˜Bn, and storing information on the availability of a corresponding sales product.

Reference numeral 34c is a cross-marketing information DB which receives a request signal for cross-marketing from one of the first to N-th advertiser PCs B1˜Bn, and transmits the corresponding signal to the advertising company or advertiser PCs B1˜Bn designated by the corresponding advertiser, and stores information for performing cross-marketing processing depending on permission.

Reference numeral 34d indicates a member information DB which stores member information, such as a member's gender, age, area, etc., so as to enable the target advertising for each member. Reference numeral 34e indicates an integrated rewards DB which receives advertisement information and product information view signals from a plurality of customer computer terminals A1˜An to update and store member-integrated rewards information, updates and stores the corresponding member-integrated rewards given according to a product purchase signal of a certain customer, and stores total per-click rewards information of a linked advertising company according to whether cross-marketing is applied or not.

Reference numeral 34f indicates an advertising costs payment management DB which stores discount rate information in advance so that the discount rate awarded to a purchasing member is proportional to charged advertising costs to be paid upon purchase of a product of a corresponding advertising company, and stores information on accumulated calculated advertising costs upon clicking of the linked advertising company according to the application of cross-marketing.

Reference numeral 36 indicates a controller which receives advertisement information and product information from the first to N-th advertiser PCs BC-Bn to post them on the web pages of a shopping mall or a search portal server, drives the integrated rewards management processor 26 according to the advertisement information and product information viewing signals transmitted from the user PCs A1˜An to accumulate and save the member-integrated rewards and accumulate the total rewards of each of linked advertising companies according to whether cross-marketing is applied or not, charges, in advance, a predetermined amount of advertising costs to be paid for the output of advertisement information, processes a discount rate awarded to a purchasing member upon purchase of a product of a corresponding advertising company in proportion to the charged advertising costs to be paid, outputs the total integrated rewards information in the link information of each of linked advertising companies according to whether cross-marketing is applied or not, receives a customer's product purchase signal to perform the discount processing of the purchase price of the corresponding customer by use of the member-integrated rewards, and drives the integrated rewards management processor 26 to update reward point data, thus performing the sales representative processing of a product uploaded by a seller.

Meanwhile, the online advertisement output control server OAOMS is integrally configured in the shopping mall server SOPS and the search portal server SPS, and therefore, it is enough to be able to perform the registration of advertisement data, the payment and settlement processing of advertising costs, discount processing, and the adding-up process of rewards of each of advertising companies linked by cross-marketing to output them on the screen, and add up rewards upon a user's click to accumulate them.

The function and operation of the thus-configured online advertisement output control system in accordance with the first embodiment of the present invention will be described in detail with reference to the accompanying drawings.

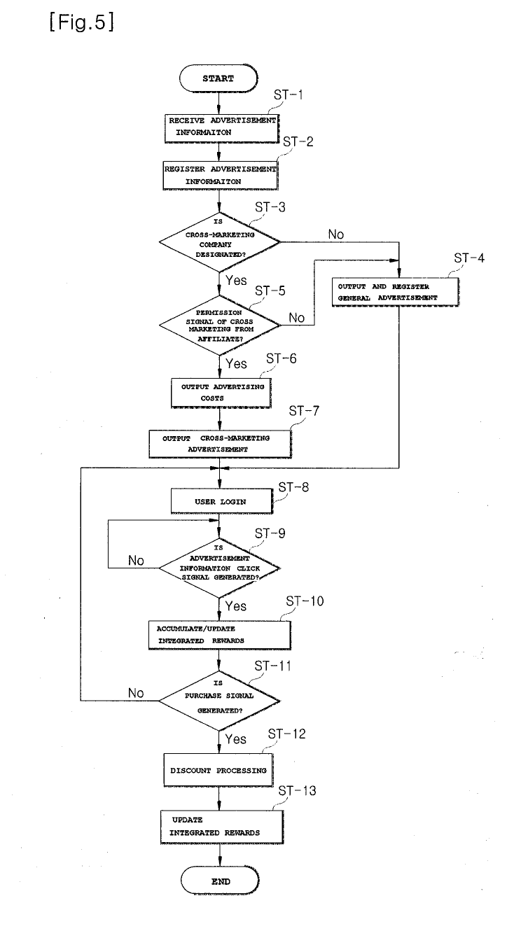

FIGS. 5, 6, 7, and 8 are flowcharts showing a signal flow of the online advertisement output control system in accordance with the first embodiment of the present invention.

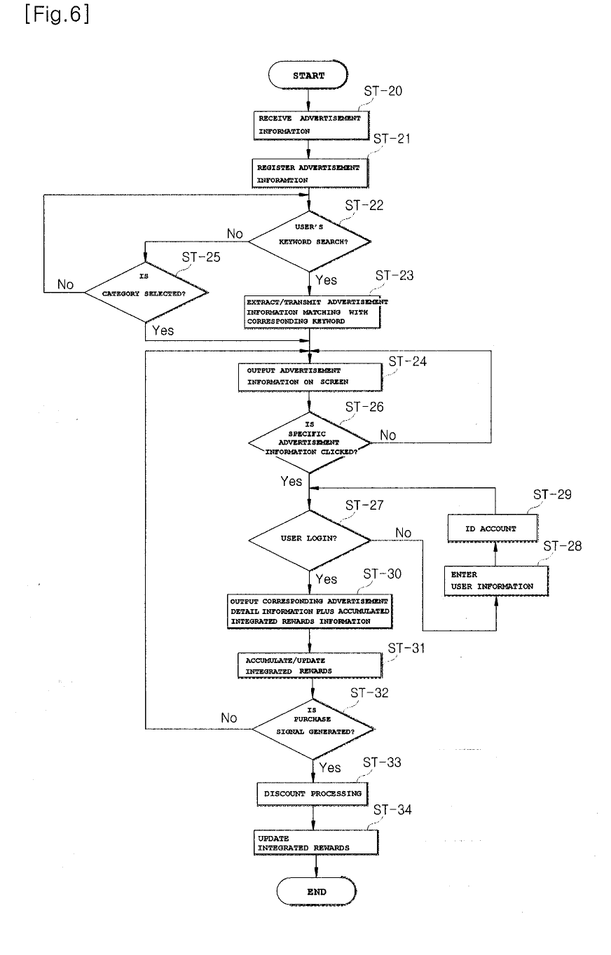

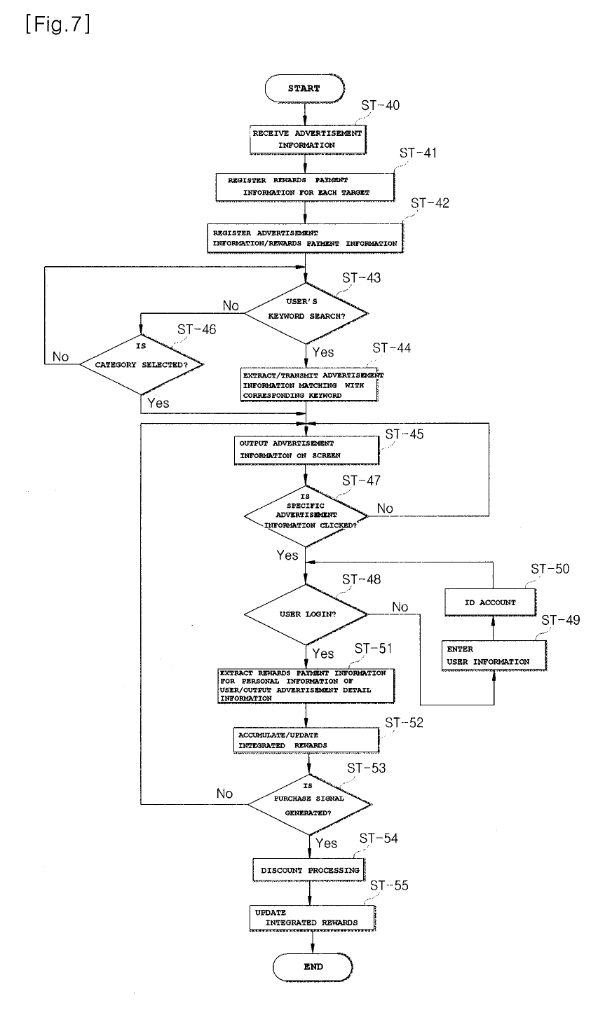

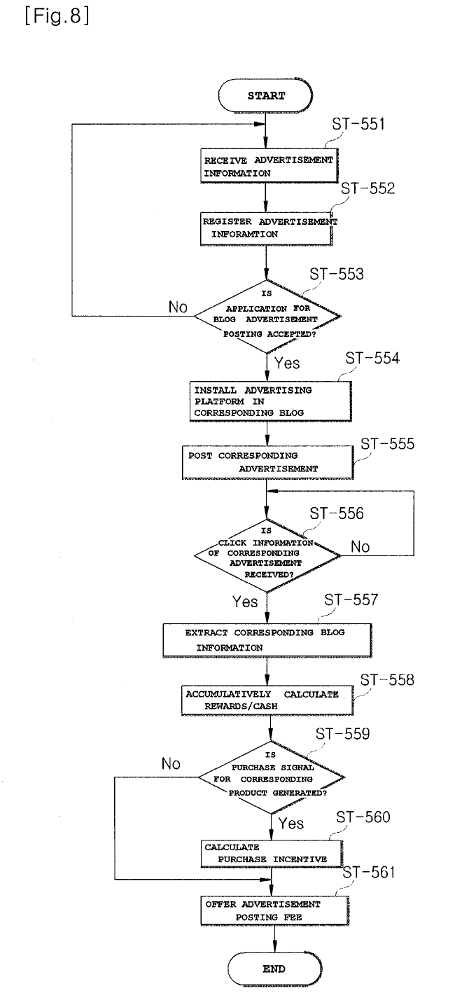

Referring to these drawings, FIG. 5 is a signal flowchart showing a method of cross-marketing utilizing the online advertisement output control system in accordance with the first embodiment of the present invention. FIG. 6 is a signal flowchart showing the procedure of processing and outputting accumulated rewards as a hidden value using the online advertisement output control system in accordance with the first embodiment of the present invention. FIG. 7 is a signal flowchart showing the procedure of differentially paying rewards for each target user by using the online advertisement output control system in accordance with the first embodiment of the present invention. FIG. 8 is a signal flowchart for proposing an advertising method using a personal blog through the online advertisement output control system in accordance with the first embodiment of the present invention.

First, referring to FIG. 5, the online advertisement output control server OAOCS that comprehensively controls this system posts corresponding advertisement information upon receipt of advertisement information from first to N-th advertiser PCs B1˜Bn (ST-1 and ST-2).

In this state, the online advertisement output control server OAOCS receives a cross-marketing company designation signal and a cross-marketing designation request signal from the advertiser PCs B1˜Bn of a certain advertising company, and transmits information on the corresponding company that applied for cross-marketing and the cross-marketing designation request signal to the advertiser PCs B1˜Bn of the advertising company designated by the advertiser, to wait a permission signal therefor (ST-3).

If the online advertisement output control server OAOCS receives the cross-marketing permission signal from the advertiser PCs B1˜Bn of the corresponding designated advertising company (ST-5), the online advertisement output control server OAOCS receives a predetermined amount of advertising costs through the advertiser PCs B1˜Bn to perform the charging processing thereof, awards discount rates pre-classified by each category of advertising costs, and posts the discount rate information (ST-6).

Then, the online advertisement output control server OAOCS posts advertisement information of a corresponding advertising company, individual accumulated integrated rewards information for each site, and total accumulated integrated rewards information caused by cross-marketing on the screen of a shopping mall homepage or search portal homepage to be outputted in conjunction with keywords designated by the advertiser (ST-7).

In other words, the site of the corresponding advertiser is outputted to the screen by entering search keywords on the shopping mall homepage screen or search portal homepage screen, information of the corresponding advertiser and URL information are posted so as to be outputted to the shopping mall homepage screen or search portal homepage screen in order to enable access to the homepage of the advertiser, and the online advertisement output control server OAOCS posts accumulated integrated reward amount information of each advertiser and total accumulated integrated rewards information caused by cross-marketing, in conjunction with the URL information of the corresponding advertiser.

In this state, if multiple users log in the online advertisement output management server OAOMS through the user PCs A1˜An (ST-8), the online advertisement output control server OAOCS performs the login process of the corresponding users.

Then, the online advertisement output control server OAOCS determines which of the user PCs A1˜An a click signal on the corresponding advertisement information is generated from (ST-9), and when the click signal is generated, the online advertisement output control server OAOCS awards rewards for the clicking behavior of the corresponding user, and integrates the rewards to accumulate and update the integrated rewards (ST-10).

In this state, the online advertisement output control server OAOCS determines which user a product purchase signal is generated from (ST-11), and when the product purchase signal is generated, discount rate information awarded for the corresponding advertised product in advance is extracted, and the corresponding discount rate is reflected, thus performing a discount process using the integrated rewards.

Then, the online advertisement output control server OAOCS deducts the corresponding discounted cost from the integrated rewards (ST-12), updates the integrated rewards information (ST-13), and re-adjusts the ranks of the sites of the advertising companies according to the accumulated integrated rewards.

Accordingly, in FIG. 5, through the online advertisement output control system in accordance with the first embodiment of the present invention, even an advertisement web site with a small amount of accumulated integrated rewards made by clicking on an advertisement and product information is able to output the corresponding site in a higher rank by adding up the accumulated integrated rewards awarded for each advertising site and outputting them to the screen through cross-marketing, thereby encouraging more users to do clicking and shopping.

Referring to FIG. 6, the online advertisement output control server OAOCS for comprehensively controlling this system posts advertisement information upon receipt of advertisement information from the first to N-th advertiser PCs B1˜Bn (ST-20).

In this state, the online advertisement output control server OAOCS registers advertisement information by linking a corresponding advertisement to keywords of a well-known search engine provided from a shopping mall server SOPS and a search portal server SPS that are linked in advance (ST-21). Especially, the online advertisement output control server OAOCS posts a display means in result information searched through the search window provided on the homepage main screens of the shopping mall server SOPS and search portal server SPS so as to provide a separate display means (icon) representing the offer of accumulated integrated rewards by company.

Then, the online advertisement output control server OAOCS determines whether or not a user's keyword search is performed from the shopping mall server SOPS and the search portal server SPS (ST-22), and extracts advertisement information matching with the keyword search word (ST-23). That is, when the online advertisement output control server OAOCS enters “flower delivery” as a keyword search word, with the URL of a specific flower delivery company stored therein, information of the company corresponding to the search word and classified in advance is outputted, and the URL information of the corresponding company is hyperlinked (ST-24). This is a well-known technology.

Of course, in the shopping mall server SOPS and the search portal server SPS, various advertisement information and site (company) information may be outputted to the screen by category selection, rather than by keyword entry (ST-25 and ST-24).

However, in the present invention, a display means (icon) for separately displaying the offer of accumulated integrated rewards in the company information outputted due to such a search result is outputted selectively in each search result. That is, a user only can be aware of the fact that accumulated integrated rewards will be awarded only by checking the display means, but cannot find out how much the amount of accumulated integrated rewards for each site is. Accordingly, the user will want to obtain detailed information by clicking on a multiplicity of corresponding advertisement information or company information outputted as a search result.

Therefore, the online advertisement output control server OAOCS determines whether a click signal on specific advertisement information is applied from the user PCs A1˜An (ST-26), and determines whether the corresponding user is a subscribed member or not. If the corresponding user is not a member, personal information of the user is inputted to perform a separate ID account procedure (ST-26 to ST-29).

If the corresponding user is a member, the online advertisement output control server OAOCS extracts accumulated integrated rewards information and advertisement or company detail information linked to corresponding advertisement information or company information in response to the click signal, and transmits them to the shopping mall server SOPS and the search portal server SPS to output them to the screen (ST-30).

Then, the online advertisement output control server OAOCS accumulates and updates the accumulated integrated rewards for the clicking behavior of the corresponding user (ST-31).

Next, the online advertisement output control server OAOCS determines which user a purchase signal is applied from (ST-32), and when the purchase signal is generated, the accumulated integrated rewards of the site with the corresponding product posted therein is checked to perform a discount process and update the accumulated integrated rewards to a zero (0) state (ST-33 and ST-34).

Through FIG. 6, if the user enters a specific keyword search word through the shopping mall server SOPS and the search portal server SPS to search product information or company information, it is possible to determine which information of the product information or company information outputted as a result value is from the company offering accumulated integrated rewards. Thus, the user will select the company offering accumulated integrated rewards before everything upon shopping, and this leads to a very high advertising effect through keyword search and the activation of shopping. Further, since accumulated integrated reward amount information is processed as a hidden value, the user clicks on the site of the corresponding company because they will want to know how much accumulated integrated rewards are accumulated for discount, thereby providing an additional advertising effect.

FIG. 7 is a signal flowchart showing a process of differentially giving rewards for each target user by using the online advertisement output control system in accordance with the first embodiment of the present invention.

First, the online advertisement output control server OAOCS for comprehensively controlling this system posts advertisement information upon receipt of advertisement information from the first to N-th advertiser PCs B1˜Bn (ST-40).

In this state, the online advertisement output control server OAOCS registers advertisement information by linking a corresponding advertisement to keywords of a well-known search engine provided from a shopping mall server SOPS and a search portal server SPS that are linked in advance. Especially, the online advertisement output control server OAOCS receives and registers rewards offer information differentiated for each user's personal information from the advertiser PCs B1˜Bn (ST-41 and ST-42).

That is, the rewards offer information differentiated for each user's personal information refers to information that an advertiser can set in a manner to offer rewards of 200 points if the user's age ranges from 15 to 25, and offer rewards of 100 points if the user's age is beyond the above age range. This information is not only limited to age, but the advertiser can offer rewards differentiated for each target user about various personal information, such as user's residential area, hour, gender, job, etc.

Then, the online advertisement output control server OAOCS determines whether or not a user's keyword search is performed from the shopping mall server SOPS and the search portal server SPS (ST-43), and extracts advertisement information matching with the keyword search word (ST-44). That is, when the online advertisement output control server OAOCS enters “flower delivery” as a keyword search word, with the URL of a specific flower delivery company stored therein, information of the company corresponding to the search word and classified in advance is outputted, and the URL information of the corresponding company is hyperlinked (ST-45). This is a well-known technology.

Of course, in the shopping mall server SOPS and the search portal server SPS, various advertisement information and site (company) information may be outputted to the screen by category selection (ST-46 and ST-45), rather than by keyword entry.

The online advertisement output control server OAOCS determines whether a click signal on a specific advertisement information is applied from the user PCs A1˜An (ST-47), and determines whether the corresponding user is a member or not. If the corresponding user is not a member, personal information of the user is inputted to perform a separate ID account procedure (ST-48 to ST-50).

If the corresponding user is a member, the online advertisement output control server OAOCS extracts accumulated integrated rewards information and advertisement or company detail information linked to corresponding advertisement information or company information in response to the click signal, and transmits them to the shopping mall server SOPS and the search portal server SPS to output them to the screen (ST-51).

Then, the online advertisement output control server OAOCS extracts rewards payment information for each target user transmitted by the advertiser in advance and stored, and determines how much rewards can be additionally accumulated by the corresponding user, accumulates the corresponding rewards, and updates the accumulated integrated rewards accumulated for the corresponding company (ST-52).

Next, the online advertisement output control server OAOCS determines which user a purchase signal is applied from (ST-53), and when the purchase signal is generated, the accumulated integrated rewards of the site with the corresponding product posted therein is checked to perform a discount process and update the accumulated integrated rewards to a zero (0) state (ST-54 and ST-55).

FIG. 8 is a signal flowchart presenting an advertising method using a personal blog through the online advertisement output control system in accordance with the first embodiment of the present invention.

First, the online advertisement output control server OAOCS for comprehensively controlling this system posts corresponding advertisement information upon receipt of advertisement information from first to N-th advertiser PCs B1˜Bn (ST-551).

In this state, the online advertisement output control server OAOCS registers advertisement information by linking a corresponding advertisement to keywords of a well-known search engine provided from a shopping mall server SOPS and a search portal server SPS that are linked in advance (ST-552).

Next, the online advertisement output control server OAOCS accepts applications for posting blog advertisements about advertisement information posted in the homepages or specific advertisement information posted in the shopping mall server SOPS and the search portal server SPS (ST-553). That is, it accepts various users' applications for posting corresponding advertisements in their own blogs about a specific advertisement.

When the acceptance of applications for ad posting is finished, the online advertisement output control server OAOCS installs an advertising platform in the corresponding blog (ST-554). In other words, the online advertisement output control server OAOCS may install an advertising platform by transmitting the blog information and advertising platform information to the search portal server SPS providing the corresponding personal blog, or may install the advertising platform in such a manner as to upload general photos.

At this time, the advertising platform to be installed in the blog is a means for transmitting, to the online advertisement output control server OAOCS, the IP of a user who visited the corresponding blog, and performing communications to receive modification information of advertisement data from the online advertisement output control server OAOCS, and the online advertisement output control server OAOCS is a means for remotely controlling advertisement information of the corresponding blog.

By this, the online advertisement output control server OAOCS determines whether a click signal on specific advertisement information is applied from the user PCs A1˜An (ST-556), and extracts the corresponding blog information. That is, it receives information of the corresponding blog and IP information of a clicking user through the advertising platform (ST-557).

By this, the online advertisement output control server OAOCS accumulatively calculates rewards or cash to be offered to the owner of the corresponding blog (ST-558). That is, parts of the entire advertising costs are paid to the blog owner for the clicking of corresponding advertisement information.

Further, the online advertisement output control server OAOCS determines which user a purchase signal is applied from (ST-559), and when the purchase signal is generated, it calculates and offers additional incentive rewards or cash to the owner of the corresponding blog (ST-560 and ST-561).

Through FIG. 8, the online advertisement output control system in accordance with the first embodiment of the present invention can post advertisements in much more blogs, and the owner of the corresponding blog can decorate his or her blog by writing various PR texts in order to sell the corresponding advertised product well and increase the number of clicks. Especially, it would be more advantageous for the blow owner to post advertisements suitable for the theme of the blog.

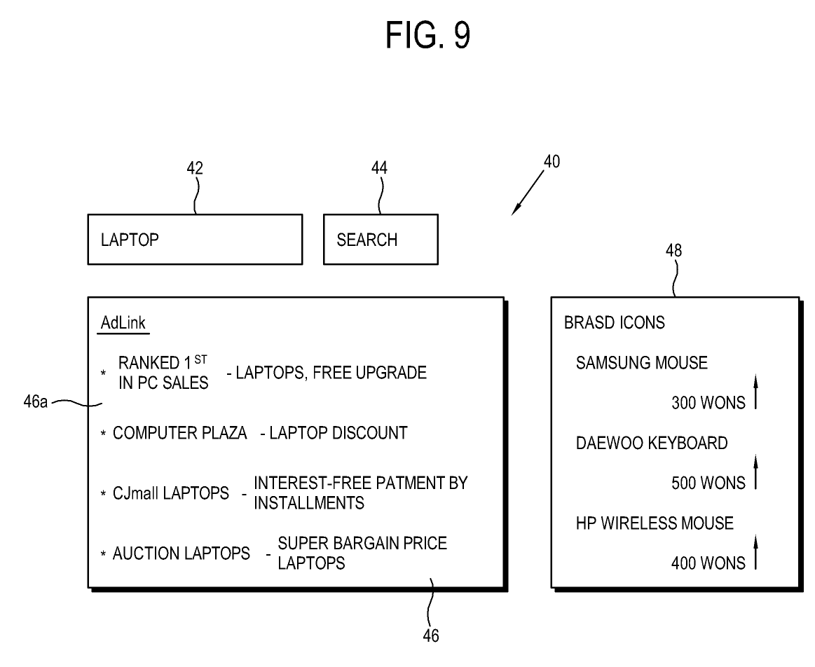

FIGS. 9, 10, and 11 are views showing brand icon output screens of the online advertisement output control system in accordance with the first embodiment of the present invention.

Referring to these drawings, the brand icon output screens of the online advertisement output control system in accordance with the first embodiment of the present invention are as shown in FIGS. 9, 10, and 11.

The brand icon used herein is a discount icon provided by an advertiser, which can be individually collected by a user and used upon a product purchase. The brand icon is different from accumulated integrated rewards in the present invention in the sense that it can be individually collected and individually used.

In the brand icon, a unique code is matched with a hidden value, wherein the icon has codes for respective products separately embedded therein and issue period information as a code embedded therein. That is, the brand icon is a discount icon that can be issued for each product or for each brand company, the issue period of which is set and the discount rate of which is differentially calculated depending on the lapse of the period.

For example, in case of the brand icon for a Samsung optical mouse as shown in FIG. 9, a discount can be granted only upon purchase of the Samsung optical mouse, and though its face value indicated is 300 wons, the face value falls with the passage of the period after issuing. Precisely, the face value is still the same, but the discountable amount falls.

Hence, users will try to find out new brand icons in portal sites or shopping sites, which will resultantly maximize the advertising effect.

The search window 40 of a search portal site has a search word entry window 42, a search word entry confirmation button 44, and an output window 46 for outputting information about the result of a search word stored therein, and the search word result output window 46 has multiple company site information 46a outputted through a search engine and posted therein.

At this time, brand icon information 48 is posted at the right side of the search word result output window 46. This information is brand icon information that is generated by the corresponding advertiser and transmitted from the online advertisement output control server OAOCS to each shopping mall server SOPS or search portal server SPS, and outputted to the screen.

Further, such brand icon information 48 can be processed in the online advertisement output control server OAOCS so as to be processed as information related to the information outputted in the search result window 46. That is, if the information outputted in the search result window 46 is information about computers, it is preferred that the online advertisement output control server OAOCS classifies the corresponding brand icon information 48 and transmits information of mousse, keyboards, laptops, desktops, etc., which are information related to computers, to output them to the screen.

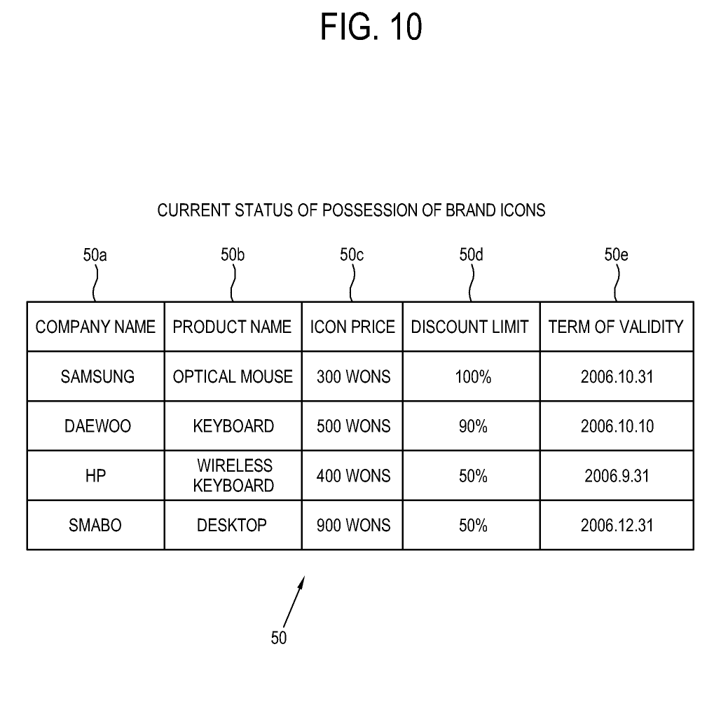

Referring to FIG. 10, such brand icon information 48 is provided to the corresponding user upon the user's clicking, and the collected brand icon information is tabled by user. That is, the brand icon table 50 collected by the user has company names 50a that issued the brand icon, product names 50b, icon prices 50c, discount limits 50d, and terms of validity 50e specified therein.

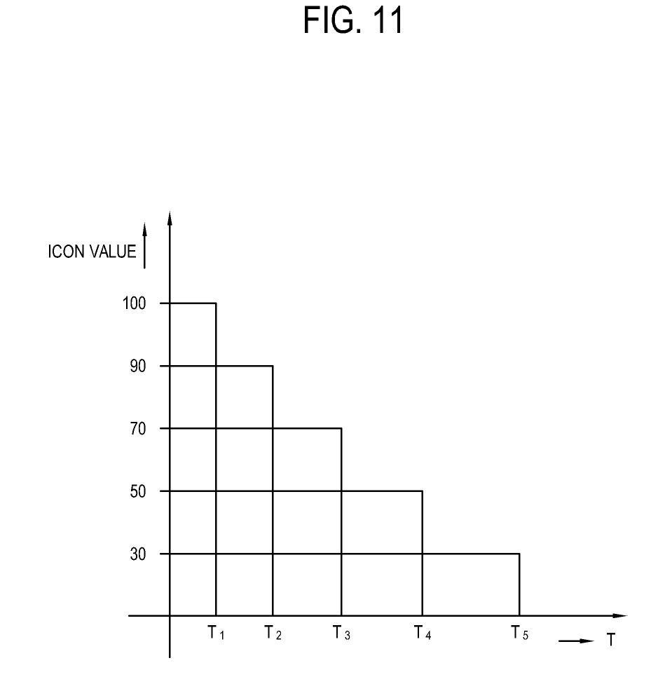

By this, when a user purchases a specific product issued from a specific company, he or she can get a discount through the brand icon and has to present the corresponding brand icon within the term of validity, the discount value as the discount limit thereof is varied with the passage of the term as shown in FIG. 11, and icon prices as face values, and discount limits are made different. The technical features thereof are similar to those of typical online gift certificates or electronic payment means, and thus will be omitted.

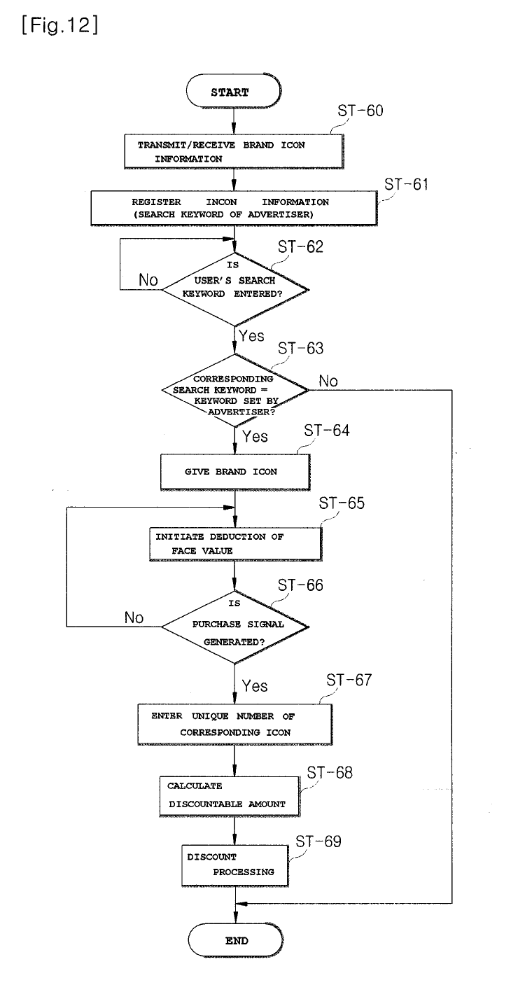

FIGS. 12, 13, and 14 are flowcharts showing a brand icon processing status through the online advertisement output control system in accordance with the first embodiment of the present invention.

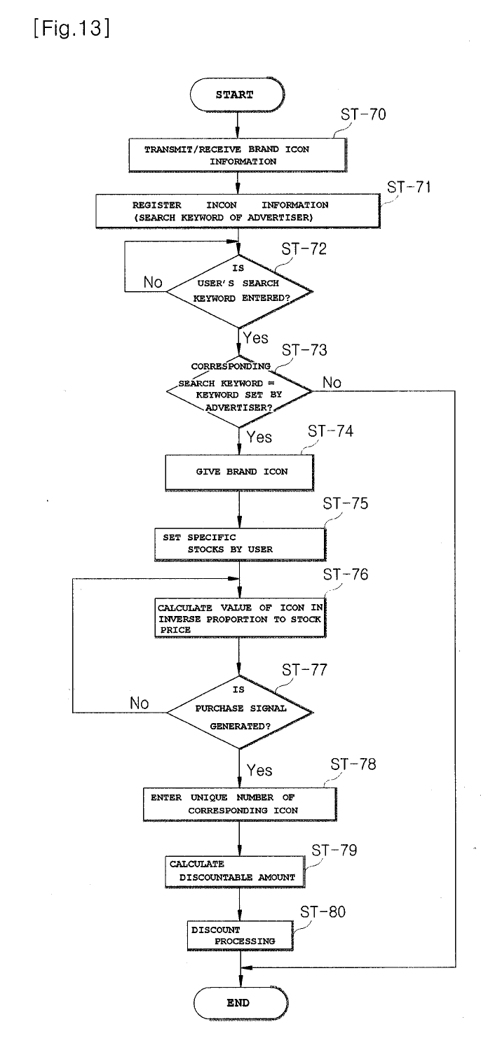

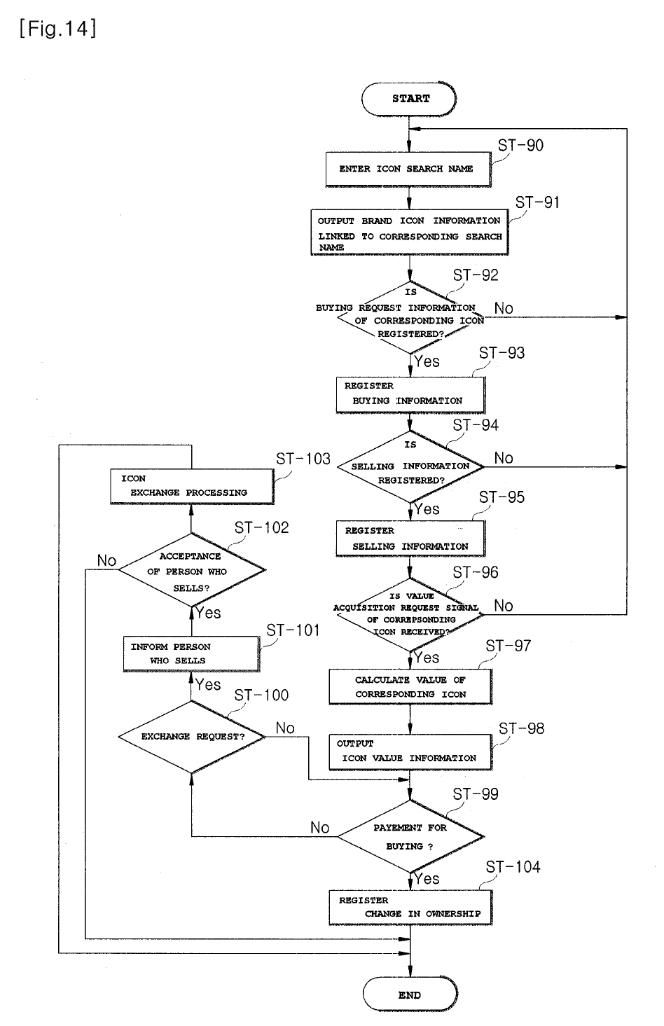

FIG. 12 shows a brand icon creation process, FIG. 13 shows a process of fluctuation of the value of a brand icon linked to the stock price of a designated company, and FIG. 14 is a view showing a transaction process of a brand icon.

First, referring to FIG. 12, the online advertisement output control server OAOCS receives brand icon issuing information and brand icon information transmitted from advertiser PCs B1˜Bn (ST-60), and receives and registers search keyword information desired by the corresponding advertiser (ST-61).

In other words, the advertiser is able to issue the corresponding brand icon and output it to the screen only when a specific search keyword among search keywords of a search portal or shopping mall is entered. The online advertisement output control server OAOCS transmits and registers the corresponding search keyword and brand icon information to the search portal server SPS or the shopping mall server SOPS.

The search portal server SPS or the shopping mall server SOPS receives the corresponding search keyword information and brand icon information and registers them in conjunction with a pre-established search engine.

In this state, the online advertisement output control server OAOCS receives a user's keyword search word from the search portal server SPS or the shopping mall server SOPS (ST-62), and determines whether the corresponding keyword matches a search word preset by the advertiser (ST-63).

Of course, the search portal server SPS or the shopping mall server SOPS may perform such a process.

In this state, if the search word entered by the user matches the search word preset by the advertiser, the online advertisement output control server OAOCS gives the corresponding user the brand icon (ST-64).

At this time, the brand icon is not provided unilaterally, but the online advertisement output control server OAOCS outputs the brand icon to the screen in the search result window of the search portal server SPS or shopping mall server SOPS. If the user clicks on this brand icon, the brand icon is given to the corresponding user. At this time, detailed information of the product linked to the corresponding brand icon is outputted as a pop-up window in the form of an advertisement.

When the brand icon is given by the user's clicking on the brand icon, the online advertisement output control server OAOCS carries out reduction of the face value for the brand icon (ST-65). That is, the passage of time is calculated to change the value of each brand icon to a discounted price for pre-stored elapsed time.

In this state, when a purchase signal for a specific product is generated from a certain user (ST-66), and a unique number of a brand icon is entered (ST-67), the online advertisement output control server OAOCS retrieves the unique number of the brand icon and extracts a discountable amount of the corresponding brand icon (ST-68). In this state, a discount process on the corresponding product is performed (ST-69).

Referring to FIG. 13, the online advertisement output control server OAOCS receives brand icon issuing information and brand icon information from advertiser PCs B1˜Bn (ST-70), and receives and registers search keyword information desired by the corresponding advertiser (ST-71).

In other words, the advertiser is able to issue the corresponding brand icon and output it to the screen only when a specific search keyword among search keywords of a search portal or shopping mall is entered. The online advertisement output control server OAOCS transmits and registers the corresponding search keyword and brand icon information to the search portal server SPS or the shopping mall server SOPS.

The search portal server SPS or the shopping mall server SOPS receives the corresponding search keyword information and brand icon information and registers them in conjunction with a pre-established search engine.

In this state, the online advertisement output control server OAOCS receives a user's keyword search word from the search portal server SPS or the shopping mall server SOPS (ST-72), and determines whether the corresponding keyword matches a search word preset by the advertiser (ST-73).

Of course, the search portal server SPS or the shopping mall server SOPS may perform such a process.

In this state, if the search word entered by the user matches the search word preset by the advertiser, the online advertisement output control server OAOCS gives the corresponding user the brand icon (ST-74).

At this time, the brand icon is not provided unilaterally, but the online advertisement output control server OAOCS outputs the brand icon to the screen in the search result window of the search portal server SPS or shopping mall server SOPS. If the user clicks on this brand icon, the brand icon is given to the corresponding user. At this time, detailed information of the product linked to the corresponding brand icon is outputted as a pop-up window in the form of an advertisement.

When the brand icon is given by the user's clicking on the brand icon, the online advertisement output control server OAOCS receive a selection signal for specific stocks from the user PCs A1˜An, and register the stock information (ST-75). In this state, the online advertisement output control server OAOCS variably calculates the discount value of the corresponding brand icon so as to be in inverse proportion to the price of the corresponding stocks (ST-76).

In other words, when the price of the corresponding designated stock falls, the value of the brand icon given rises as much as the corresponding rate. On the contrary, when the price of the corresponding designated stocks rises, the value of the brand icon given falls as much as the corresponding rate. Such designatable stocks are blue chip stocks presented in advance, and fluctuations in the price of the corresponding stocks are not sharp. Even if the stock price falls by a maximum of 10%, the fluctuation rate of the brand icon becomes less than 10 wons because the face value is mostly at the 100 wons level. However, fluctuations of the actual value that the user feels are greater than actual, and thus the user may understand that the advertiser can increase the advertising effect with small marketing costs, thereby providing a compensation for fluctuations in the value of the brand icon in conjunction with the stock price.

Especially, the desginatable stocks may be restricted to those of the company that issued the corresponding brand icon.

In this state, when a purchase signal for a specific product is generated from a certain user (ST-77), and a unique number of a brand icon is entered (ST-78), the online advertisement output control server OAOCS retrieves the unique number of the brand icon to search for the stocks linked to the corresponding brand icon and extracts a discountable amount of the corresponding brand icon depending on fluctuations in the corresponding stock price (ST-79). In this state, a discount process on the product is performed (ST-80).

Referring to FIG. 14, the online advertisement output control server OAOCS is provided with a transaction tool for brand icon transaction. Further, a search tool for searching for other brand icons is also provided.

In order for a certain user to purchase an optical mouse released by Samsung Electronics, he or she has to collect more Samsung mouse brand icons that has been not collected because the more he or she collects the brand icons, the greater the discount amount. For this purpose, transactions are made.

First, when a specific brand icon search name is entered and a search signal is applied from the PC A1˜An of a certain user (ST-90), the online advertisement output control server OAOCS extracts brand icon information linked to the corresponding search name and outputs it to the screen (ST-91).

If the corresponding user transmits a purchase request signal for a specific brand icon, the online advertisement output control server OAOCS registers the corresponding brand icon information and buying information (ST-92 and ST-93).

In this state, when the online advertisement output control server OAOCS receives selling information about the corresponding brand icon from the PC A1˜An of a certain user, it registers the corresponding selling information (ST-94 and ST-95). In this state, when a value check signal of the corresponding brand icon is applied from a user who wants to buy the corresponding brand icon, the online advertisement output control server OAOCS calculates a discount amount based on the corresponding brand icon information and outputs it to the screen (ST-96 to ST-98).

By this, when a buying signal is applied from the PC A1˜An of the purchaser of the corresponding brand icon (ST-99), the online advertisement output control server OAOCS changes the owner of the corresponding brand icon and registers it (ST-104).

If the online advertisement output control server OAOCS receives not a buying signal but an exchange signal of the corresponding brand icon (ST-100), exchange information of the corresponding brand icon is transmitted to the PC A1˜An of the person who wants to sell the corresponding brand icon (ST-101), and processes the exchange of the icon and the change of the owner according to acceptance or non-acceptance (ST-102 and ST-103).

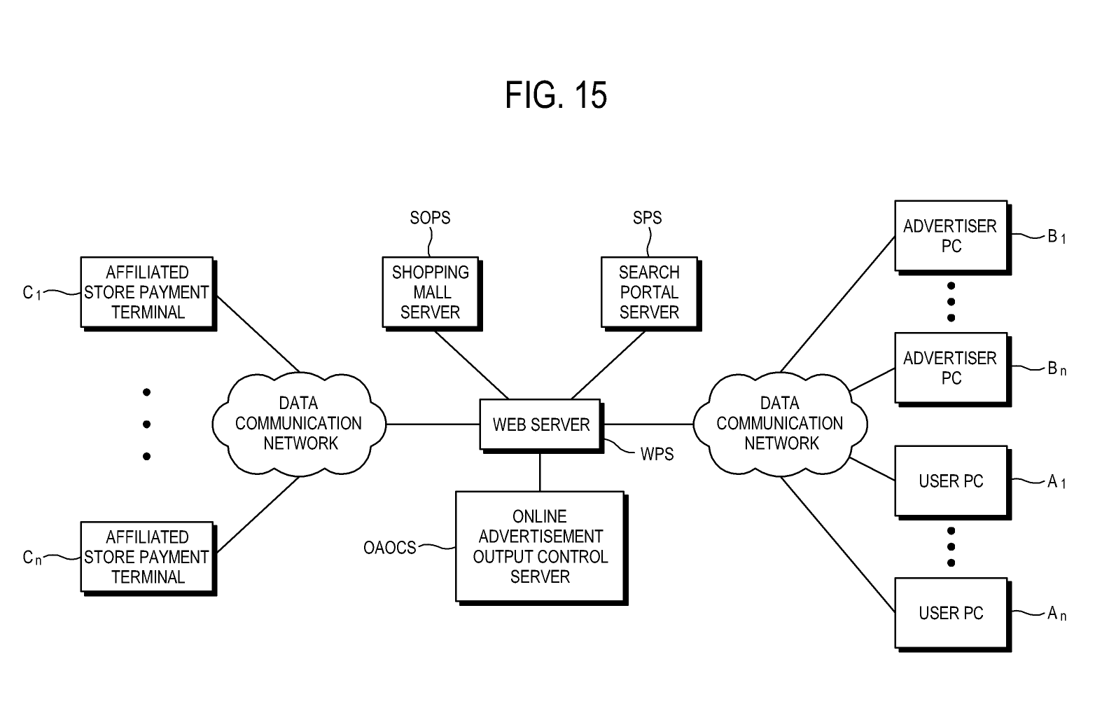

FIG. 15 is a block diagram showing the configuration of a system for executing offline rewards processing working in conjunction with the online advertisement output control system in accordance with the first embodiment of the present invention.

Referring to this drawing, the system for executing offline rewards processing working in conjunction with the online advertisement output control system in accordance with the first embodiment of the present invention is a system in which affiliated stores can use accumulated integrated rewards in accordance with this embodiment.

For this, the system of the present invention provides user PCs A1˜An having a communication module, such as a modem, and a browser embedded therein so as to access the main screen of a shopping mall or search portal and click on a search result through searching for shopping or through searching of specific information, thus outputting corresponding search result information on the screen.

There are provided advertiser terminals B1˜Bn which provide advertising payment costs for each advertiser or each product of an advertiser, and perform the viewing and registration of advertisement information in order to set a desired site or product advertising data in the online advertisement output control server OAOCS.

The online advertisement output control server OAOCS is a server which processes the settlement of per-click advertising costs for advertisement information registered by a corresponding advertiser in real time, calculates accumulated integrated rewards by advertiser site or product category, displays the calculated accumulated integrated rewards on the screen of a shopping mall, a search portal, or an affiliated store payment terminal, and performs a discount process and the payment of the price based on the accumulated integrated rewards.

Furthermore, the online advertisement output control system in accordance with the first embodiment of the present invention provides user PCs A1˜An which access to a variety of websites, such as shopping malls, search portals, respective e-commerce malls, personal blogs, etc., having advertisement information and product information posted therein to output the corresponding advertisement information on the screen, and a shopping mall server SOPS and a search portal server SPS which are linked to the online advertisement output control server OAOCS to upload advertisement information to the online advertisement output control server OAOCS, register marketing advertisement information, and receive advertising costs settlement information.

Meanwhile, there are provided affiliated store payment terminals C1˜Cn which output accumulated integrated rewards information to the screen so as to use accumulated integrated rewards in the online advertisement output control server OAOCS, and receive discount price or rewards offer information from the online advertisement output control server OAOCS to perform payment processing.

The system of the present invention thus-configured is limited to the case where an offline affiliated store sells a product operating in the shopping mall server SOPS. Only the corresponding product can be discounted through accumulated integrated rewards.

For this, the online advertisement output control server OAOCS receives corresponding product information and payment amount information from the affiliated store payment terminals C1˜Cn, and transmits discount amount information to the corresponding affiliated store payment terminals C1˜Cn for processing thereof. At this time, the online advertisement output control server OAOCS is also enough to be able to give a discount by offering rewards in the future or giving a refund in the future, rather than giving a discount in real time through the corresponding affiliated store payment terminals C1˜Cn.

In such a system, specific products provided in affiliated stores, which are offline stores, should be marked with discounted products through accumulated integrated rewards. Further, discounts on the corresponding products by the online advertisement output control server OAOCS covers both online and offline products in real time. Thus, the offline stores cannot be aware of how much the corresponding product is discounted, and at the point of time when the affiliated store payment terminals C1˜Cn of the offline stores transmit a payment signal to the online advertisement output control server OAOCS, the integrated rewards accumulated in the online advertisement output control server OAOCS are all discounted.

Accordingly, a user in the offline stores cannot get any discount at all if there are no accumulated integrated rewards for the corresponding product, and may get greater discounts than thought. Such a system can activate the sales of the corresponding product much more, and the user can get the fun of shopping once he or she understands the system.

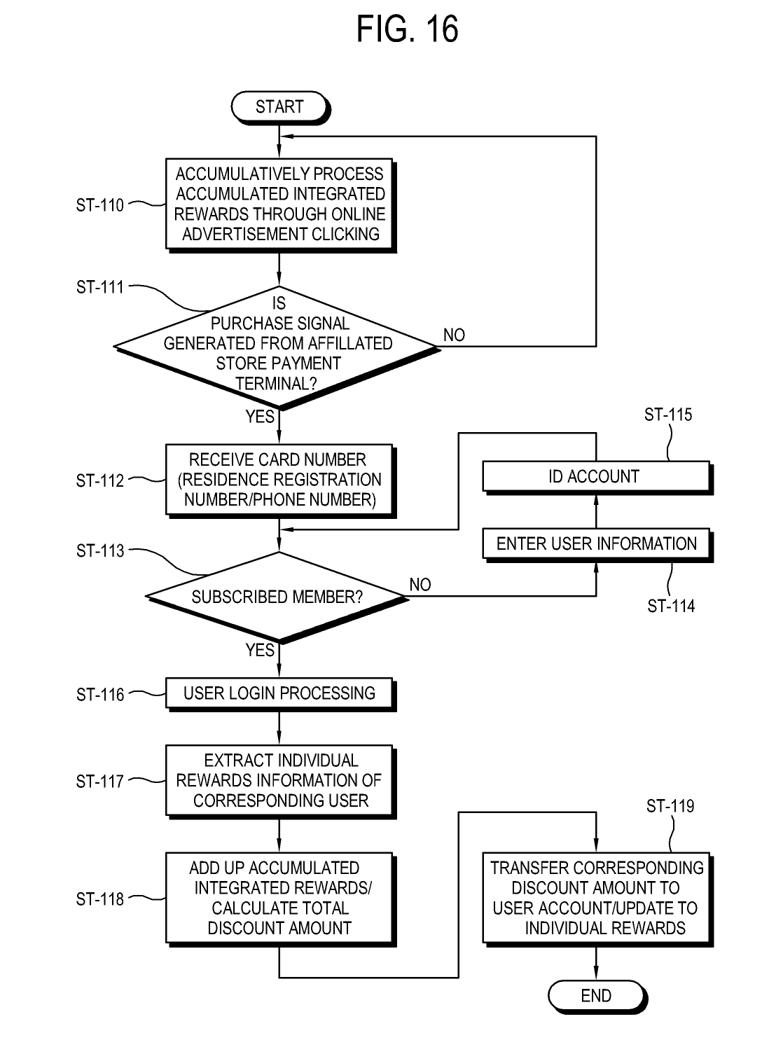

FIG. 16 is a flowchart showing a signal flow through the system of FIG. 15.

First, in the present invention, accumulated integrated rewards are accumulated in real time through the online advertisement output control server OAOCS. That is, accumulated integrated rewards are accumulated by product, category, or company by clicking on advertisement information or product information posted in a shopping mall or search portal. The present applicant already filed an application for this system. In other words, step ST-110 is a well-known technique.

By this, with regard to the accumulated integrated rewards accumulated in the online advertisement output control server OAOCS, if a user generates a purchase signal for a specific product while doing offline shopping, information about the corresponding product (ST-111), price information, and credit card information (or resident registration number/cell phone number) are transmitted from the affiliated store payment terminals C1˜Cn to the online advertisement output control server OAOCS (ST-112).

Then, the online advertisement output control server OAOCS determines whether or not the corresponding user is a subscribed member based on the corresponding user's personal information or card information (ST-113). If the user is not a subscribed member, the user transmits user information to the online advertisement output control server OAOCS through the affiliated store payment terminals C1˜Cn (ST-114), and receive an ID account (ST-115) and subscribes for membership.

In this state, the online advertisement output control server OAOCS performs login processing of the corresponding user (ST-116), extracts individual rewards information of the corresponding user (ST-117), and adds up accumulated integrated rewards for the corresponding product and individual rewards to calculate the total discount amount (ST-118).

Further, the online advertisement output control server OAOCS performs discount processing upon payment while transmitting the discount amount information to the affiliated store payment terminals C1˜Cn and outputting it to the screen. It is also possible to offer as much rewards as the corresponding discount amount in the future or transfer the corresponding discount amount to the user's account in the future (ST-119).

This is because the online advertisement output control server OAOCS already has the corresponding credit card number registered therein, thus enabling it to transfer the corresponding discount amount to the account for payment linked to the corresponding credit card.

Hereinafter, an online advertisement output control system in accordance with a second embodiment of the present invention will be described in detail with reference to the accompanying drawings.

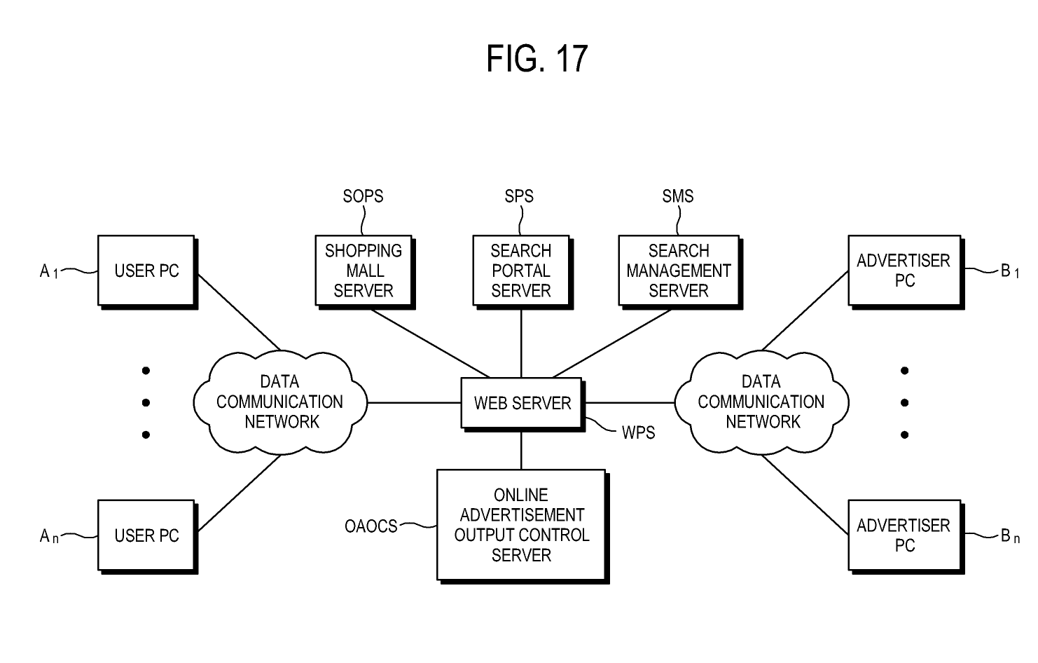

FIG. 17 is a block diagram showing the configuration of an online advertisement output control system in accordance with a second embodiment of the present invention.

Referring to this drawing, the online advertisement output control system in accordance with the second embodiment of the present invention is an online advertisement output control system, which can increase attention on advertisements or sites from users and activate the output of online advertisement information by outputting stars' image information and moving image information to the screen along with the display of accumulated amounts for each site outputted as each search result.

In other words, the online advertisement output control system in accordance with the second embodiment of the present invention is a system, which can post stars' image or moving image information in a corresponding advertising site and output the corresponding stars' image or moving image information upon outputting advertisement detail information or product detail information in order to increase ad exposure effects.

For this, the online advertisement output control system in accordance with the second embodiment of the present invention provides user PCs A1˜An having a communication module, such as a modem, and a browser embedded therein so as to access the main screen of a shopping mall or search portal and click on a search result through searching for shopping or through searching of specific information, thus outputting corresponding search result information and star's registration information on the screen.

There are further provided advertiser terminals B1˜Bn which provide advertising payment costs for each advertiser or each sales product of an advertiser, and also perform the viewing and registration of advertisement information in order to set a desired site or product advertising data and star registration information in the online advertisement output control server OAOCS.

The online advertisement output control server OAOCS is a server which processes the settlement of per-click advertising costs for advertisement information registered by a corresponding advertiser in real time, calculates accumulated integrated rewards by advertiser site or product category, displays the calculated accumulated integrated rewards on the screen of a shopping mall, a search portal, or an affiliated store payment terminal, performs discount processing and purchase payment based on the accumulated integrated rewards, and registers the transmitted star information in the shopping mall or search portal server.

Furthermore, the online advertisement output control system in accordance with the second embodiment of the present invention provides user PCs A1˜An which access to a variety of websites, such as shopping malls, search portals, respective e-commerce malls, personal blogs, etc., having advertisement information and product information posted therein to output the corresponding advertisement information on the screen, and a shopping mall server SOPS and a search portal server SPS which are linked to the online advertisement output control server OAOCS to upload advertisement information to the online advertisement output control server OAOCS, register marketing advertisement information, receive advertising costs settlement information, and post star registration information in the homepage.

Meanwhile, there is further provided an star management server SMS, which transmits and registers star image and moving image information, new release information, star homepage information, etc. to the online advertisement output control server OAOCS, and is given a per-click payment amount of the corresponding information.

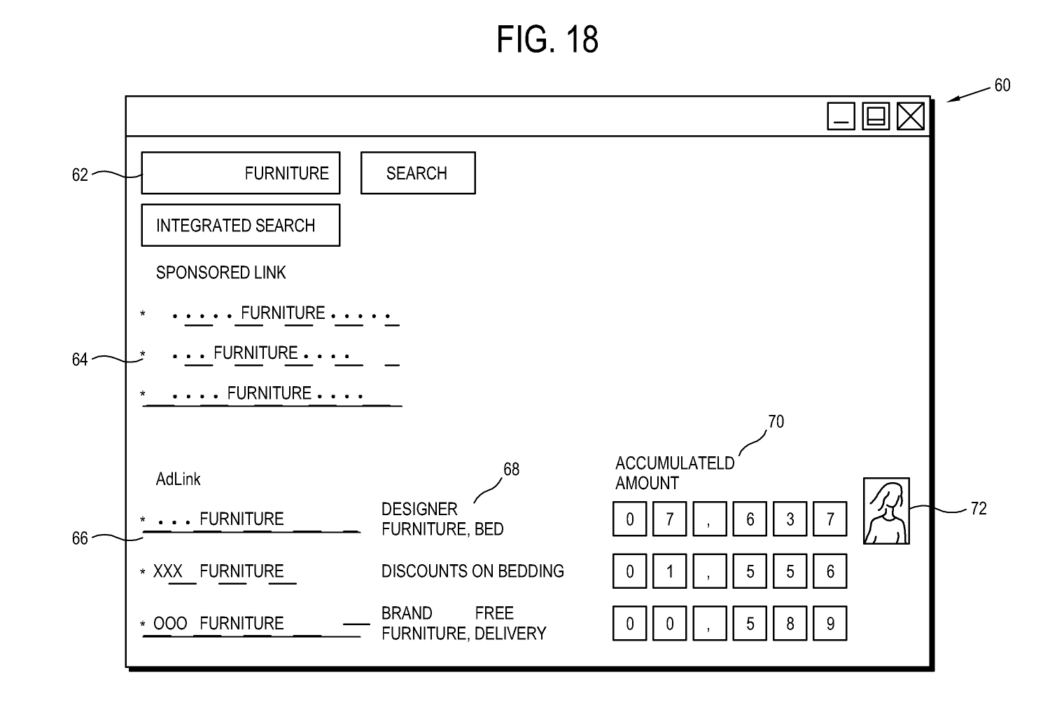

FIGS. 18, 19, and 20 are views showing a star information posting state through the online advertisement output control system in accordance with the second embodiment of the present invention.

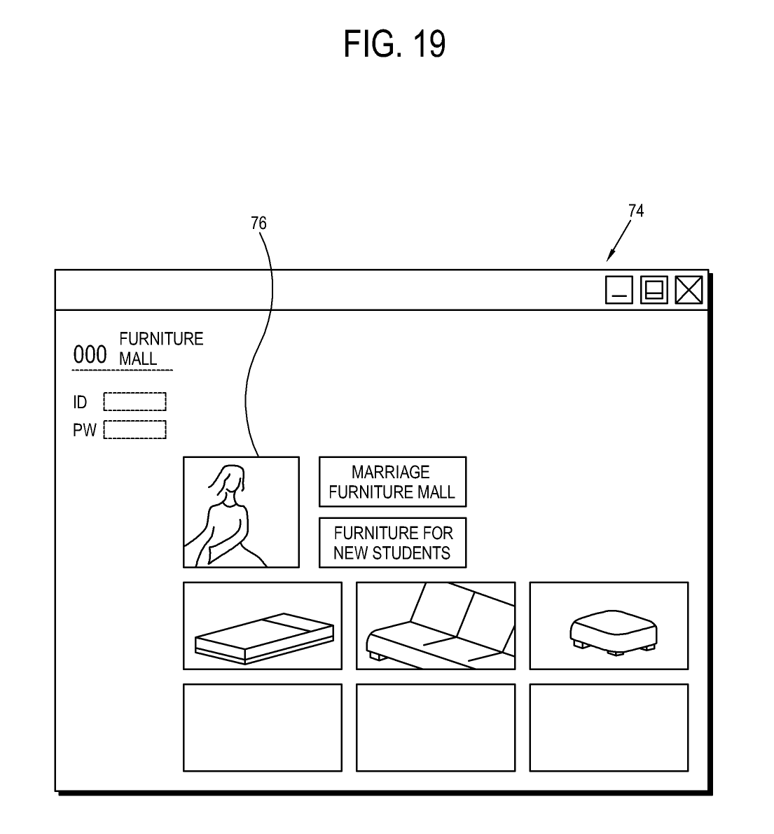

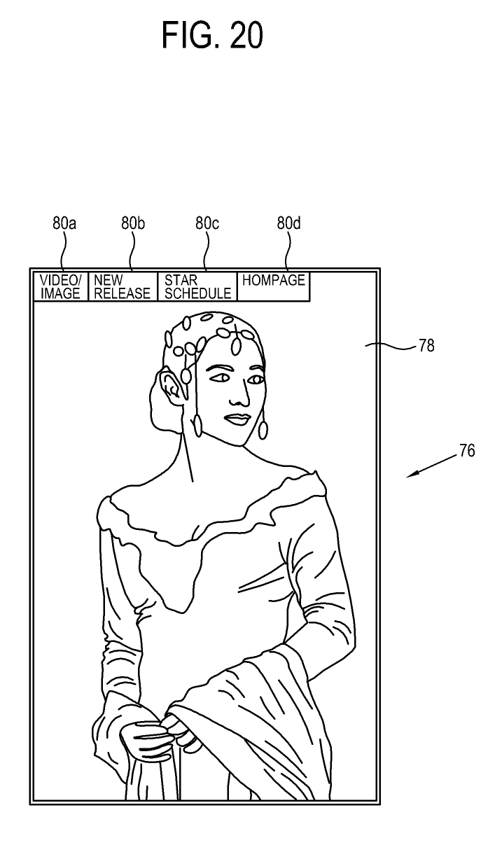

Referring to these drawings, FIG. 18 is a view showing a state of posting star registration information in specific search result information of a search result window provided in the homepage of a search portal, FIG. 19 is a view showing a state of posting a star image outputted upon clicking on the corresponding search result information and accessing the homepage of a shopping mall company, and FIG. 20 is a view showing information posted in the star registration information.

In the present invention, a state of posting a star image in the homepage of a search portal will be described by way of example. Referring to FIG. 18, a well-known search word entry window 62 for entering a search keyword is provided in the homepage 60 of a search portal, and result output windows 64 and 66 for outputting a result of entry of a specific search word keyword are prepared in the search word entry window 62.

Information 68 linked to general shopping mall companies and link information 68 of shopping mall companies having star registration information posted therein are outputted in the result output windows 64 and 66, respectively. That is, accumulated integrated rewards information 70 and a star registration image 72 are outputted at the right side of link information 68 of a specific shopping mall company.

At this time, if the user clicks on the link information 68 of the corresponding shopping mall company or clicks on the star registration image 72, he or she can access the homepage 74 of the shopping mall company linked to the corresponding information as shown in FIG. 19.

A star registration image 76 is posted in the homepage 74.

At this time, in the system of the present invention, the online advertisement output control server OAOCS manages portrait rights for the corresponding star registration images through reception and transmission of information from/to the star management server SMS, and manages the duration of use of the portrait rights and per-click fees for each of the corresponding registration images. In case of image registration as well, the online advertisement output control server OAOCS may transmit and post a star image in the homepage of a corresponding linked company in a plug-in manner. Also, the linked company may process the corresponding star image and use it after gaining approval through the online advertisement output control server OAOCS or the star management server SMS.

The star registration information 78 includes, as shown in FIG. 20, moving image/image information 80a, new release information 80b, star schedule information 80c, and homepage information 80d. The moving image/image information 80a is hyperlink information for outputting pre-linked corresponding star moving image file or image file in response to a user's click, the new release information 80b is hyperlink information for outputting new release information of a corresponding star in response to a user's click, the star schedule information 80c is hyperlink information which links star schedule data by updating in the star management server SMS, and the homepage information 80d is hyperlink information which links the mini homepage of a star.

By this, the star management agency is able to perform star marketing by posting information of the corresponding star in the shopping mall server SOPS or the search portal server SPS, and the advertising company or shopping company linked to search words of the corresponding shopping mall server SOPS or the search portal server SPS is able to induce users' clicking by using star images, which is very efficient as a means of mutual marketing.

The functions and operation of the thus-configured online advertisement output control system in accordance with the second embodiment of the present invention will be described in detail with reference to the accompanying drawings.

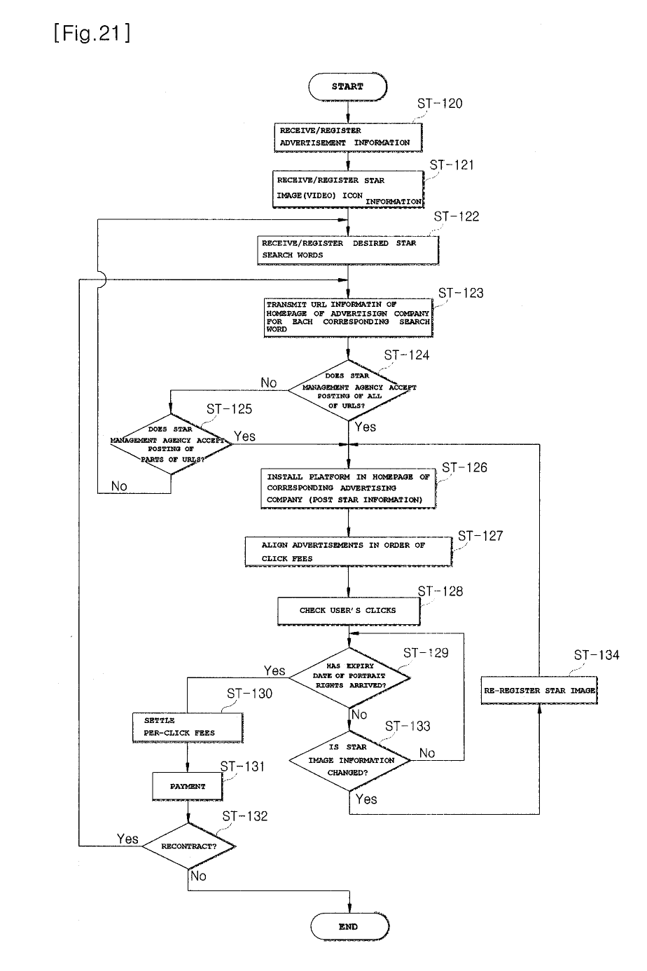

FIGS. 21, 22, and 23 are flowcharts showing a signal flow of the online advertisement output control system in accordance with the second embodiment of the present invention.

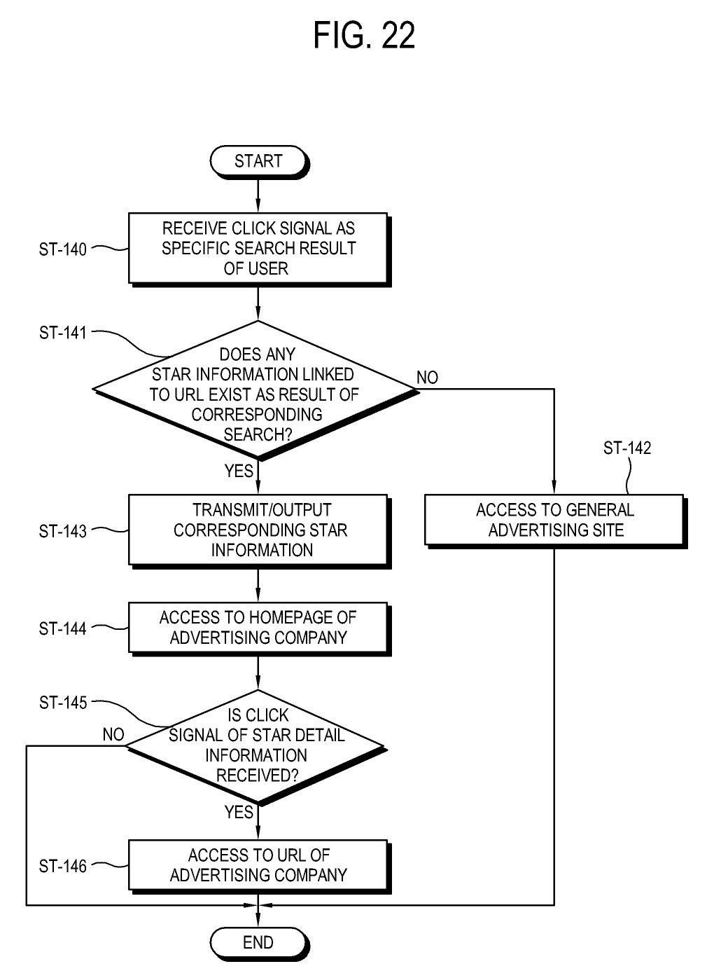

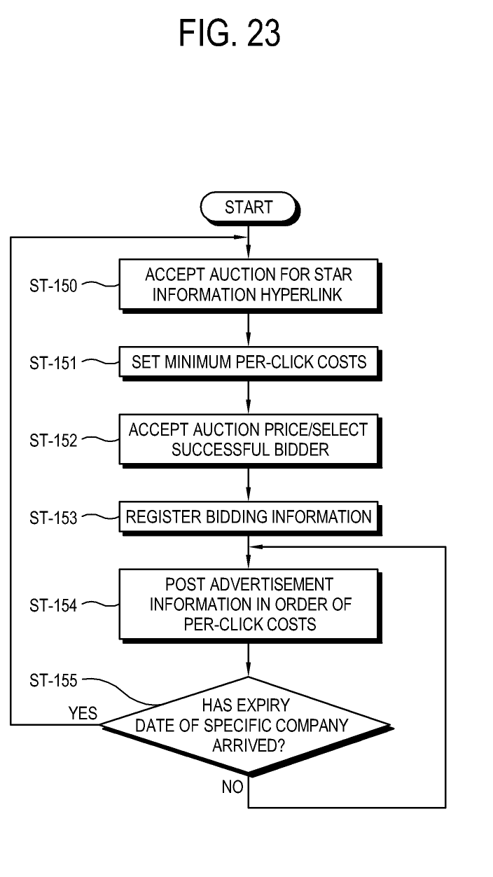

Referring to these drawings, FIG. 21 is a view showing a process of posting star registration information, FIG. 22 is a view showing a process of outputting star registration information, and FIG. 23 is a view showing a procedure of auction processing for the portrait rights of a star.

First, referring to FIG. 21, the online advertisement output control server OAOCS for comprehensively controlling this system posts corresponding advertisement information upon receipt of advertisement information from first to N-th advertiser PCs B1˜Bn (ST-120). Further, the online advertisement output control server OAOCS receives desired search words from the advertiser so as to get the search result of the corresponding product or linked company (ST-122).

In this state, the online advertisement output control server OAOCS registers advertisement information by linking a corresponding advertisement to keywords of a well-known search engine provided from a shopping mall server SOPS and a search portal server SPS that are linked in advance.

Then, the online advertisement output control server OAOCS receives, from the star management server SMS, star registration information about advertisement information posted in the homepage or specific advertisement information posted in the shopping mall server SOPS and the search portal server SPS. At this time, the process of portrait rights auction with the corresponding star management agency will be discussed later.

The online advertisement output control server OAOCS transmits, to the star management server SMS, the URL information of the homepage of an advertising company linked to search words of the shopping mall server SOPS and the search portal server SPS (ST-123). Then, the corresponding star management agency determines whether the product or company of the corresponding advertising company matches the concept of the corresponding star through the URL information of the homepage of the advertising company.

From the result of determination, the online advertisement output control server OAOCS receives, from the corresponding star management server SMS, a signal of acceptance of posting star information to the corresponding advertising company.

If the star management agency accepts only parts or all of multiple advertising company information transmitted to the star management server SMS from the online advertisement output control server OAOCS (ST-124 and ST-125), star information is posted in the selectively accepted homepage information of the advertising company, followed by being processed to be linked to the shopping mall server SOPS and the search portal server SPS or the homepage of the advertising company.

At this time, a platform for the management of star images transmitted by the online advertisement output control server OAOCS should be installed in the shopping mall server SOPS and the search portal server SPS or the homepage of the advertising company (ST-126). In other words, the platform for the management of star images is a means installed in the server in a plug-in type to communicate with the online advertisement output control server OAOCS. The online advertisement output control server OAOCS updates information of the corresponding star by communication with the corresponding server to output latest information to the user through the corresponding server.

Additionally, it is preferred for the online advertisement output control server OAOCS to align advertising company link information linked to star images posted in the shopping mall or search portal in the order of per-click fees to be provided to the star management agency upon clicking on an image of the corresponding star (ST-127). The contract for per-click fees is made differently for each star, and the online advertisement output control server OAOCS re-aligns advertising company information with high per-click fees so as to be linked in order.

In this state, the online advertisement output controls server OAOCS adds up and checks user click signals (ST-128), and checks whether the expiry date of the portrait rights of the corresponding star information has arrived or not (ST-129).

If the expiry date of the portrait rights of the corresponding star information has arrived, the online advertisement output control server OAOCS adds up click fess of the corresponding star and makes payment therefor (ST-130 and ST-131), informs the corresponding advertiser PCs B1˜Bm of the status to determine whether to recontract or not (ST-132).

Further, if the online advertisement output control server OAOCS receives a new star image from the star management server SMS, with the expiry date of the portrait rights not arrived yet, it changes the corresponding star image and re-registers it (ST-133 and ST-134).

Referring to FIG. 22, if the user PCs A1˜An click on link information of a specific advertising company or shopping company in the homepages of the shopping mall server SOPS and the search portal server SPS accessed by, a click signal is applied to the online advertisement output control server OAOCS to determine whether any star information linked to the URL of the link information exists in the database as a result of search (ST-140 and ST-141).

If no star information linked to the URL of the corresponding link information exists in the database, detail information of the corresponding link information is accessed and outputted to the web browser of the corresponding user (ST-142).

On the other hand, if any star information linked to the URL of the corresponding link information exists in the database, the online advertisement output control server OAOCS extracts the corresponding star information from the DB and transmits it to the web browser of the user PCs A1˜An (ST-143).

Simultaneously, the online advertisement output control server OAOCS transmits the homepage of the advertising company or shopping company of the link information linking the corresponding star information to the web browser of the corresponding user PC A1˜An to output it to the screen (ST-144).

At this time, when the online advertisement output control server OAOCS receives, from the user PCs A1˜An, a click signal for star moving image/image information, new release information, star schedule, and homepage among the corresponding star information (ST-145), it transmits the URL of detail information of the corresponding star to the web browser of the user PCs A1˜An to output it to the screen (ST-146).

Referring to FIG. 23, the online advertisement output control server OAOCS accepts an auction for a hyperlink of star information registration from companies having sites which desire a link, such as multiple advertisers or advertising companies, shopping companies, etc. (ST-150).

At this time, the online advertisement output control server OAOCS registers information of a star to be linked in the homepages in advance, and allows each of the advertisers or advertising companies, the shopping companies, etc. to access and view it. Auction prices vary by star, and auctions are carried out, with only a minimum auction price presented.

In other words, the online advertisement output control server OAOCS sets a limit price on per-click fees of low levels, and accepts an auction (ST-151).

When the auction is finished, the online advertisement output control server OAOCS selects a successful bidder (ST-152), and registers the bidding information in the DB and transmits it to the advertiser PCs B1˜Bn of a participating company (ST-153).

Further, the online advertisement output control server OAOCS posts the corresponding advertisement information in the homepages of the shopping mall server SOPS or search portal server SPS in the order of per-click advertising costs (ST-154). At this time, an advertising platform for performing communication with the online advertisement output control server OAOCS is installed in the homepage of a link site of the shopping mall server SOPS, search portal server SPS, or advertising company, and communication between the advertising platform and the online advertisement output control server OAOCS is carried out. The online advertisement output control server OAOCS determines whether the expiry date of posting star information for each company has arrived by checking the DB about star information in real time (ST-155).

At this time, the expiry date of posting star information for each company varies by company. Hence, if the expiry date of posting star information of a certain company has passed and a recontract is not desired, an auction for posting the corresponding star information is carried out again.

Hereinafter, an online advertisement output control system in accordance with a third embodiment of the present invention will be described in detail with reference to the accompanying drawings.

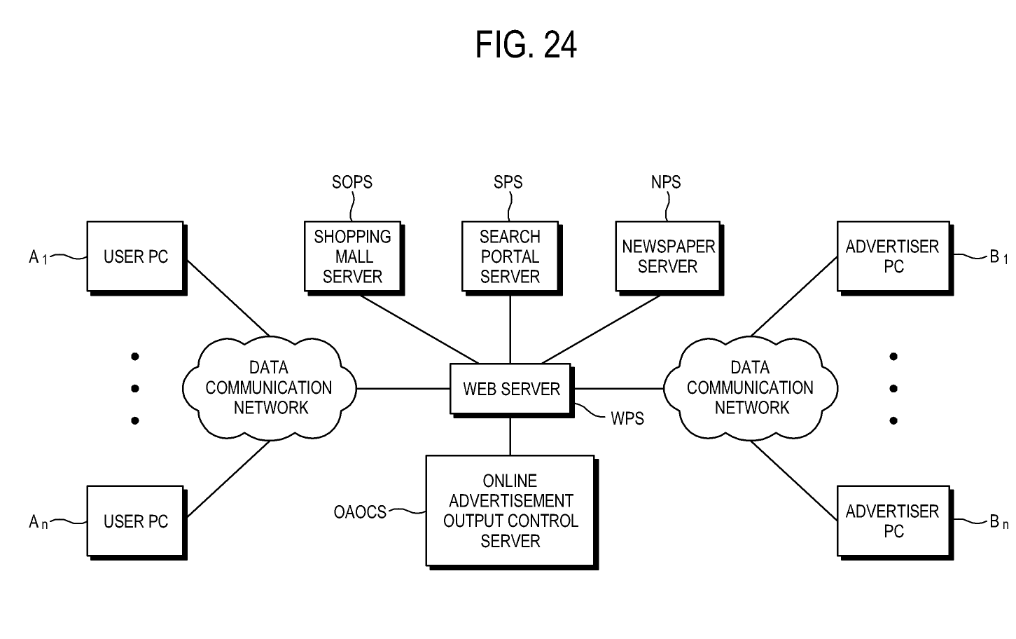

FIG. 24 is a block diagram showing the configuration of an online advertisement output control system in accordance with a third embodiment of the present invention.

Referring to this drawing, the online advertisement output control system in accordance with the third embodiment of the present invention is an online advertisement output control system, which can achieve the correct classification and matching of advertisements by allowing users to take part in setting the ad category and ad title of a site or ad information outputted as a result of keyword search of a portal site or generating a correction signal for the site or ad, the category of which is wrongly classified.

Additionally, the online advertisement output control system in accordance with the third embodiment of the present invention is an online advertisement output control system, which can achieve advertisement matching with a news article or text by allowing users to determine and set, regarding advertisements posted in a variety of text files provided in news articles or blogs provided by a portal site, whether the content of a corresponding news article or text file matches with the content of an advertisement, and generating a correction signal for a wrongly matched ad.

In other words, while the existing Google advertising method is a method that searches for keywords repeated in text files, such as news articles, and exposes advertisement information related to the corresponding keywords in the middle of the corresponding text files, the advertising method using the online advertisement output control system in accordance with the third embodiment of the present invention is a method that selects whether the content of the corresponding text files matches a posted advertisement by a user's participation, and changes the posting of the advertisement by taking the selection percentage into account.

For this, the online advertisement output control system in accordance with the third embodiment of the present invention provides user PCs A1˜An having a communication module, such as a modem, and a browser embedded therein so as to access the main screen of a shopping mall or search portal and enter a selection signal about whether an advertisement posted in a news article or various text files stored in the server are matched or not or enter a recommended ad word.

There are provided advertiser terminals B1˜Bn which provide advertising payment costs for each advertiser or each product of an advertiser, and perform the viewing and registration of advertisement information in order to set a desired site or product advertising data in the online advertisement output control server OAOCS.

The online advertisement output control server OAOCS is a server which processes the settlement of per-click advertising costs for advertisement information registered by a corresponding advertiser in real time, calculates accumulated integrated rewards by advertiser site or product category, displays the calculated accumulated integrated rewards on the screen of a shopping mall, a search portal, or an affiliated store payment terminal, performs discount processing and purchase payment based on the accumulated integrated rewards, posts the corresponding advertisement in various text files, such as a news article, of a search portal or shopping mall, and receives the matching or non-matching of the advertisement and recommended word data for advertisement from the user PCs A1˜An to change the posted advertisement.

Furthermore, the online advertisement output control system in accordance with the third embodiment of the present invention provides a shopping mall server SOPS and a search portal server SPS, which access to a variety of websites, such as shopping malls, search portals, respective e-commerce malls, personal blogs, etc., having advertisement information and product information posted therein to output the corresponding advertisement information in the middle of the text files, are linked to the online advertisement output control server OAOCS to upload advertisement information to the online advertisement output control server OAOCS, register marketing advertisement information, receive advertising costs settlement information, and post text files, such as news information, in the homepage.

Meanwhile, there is provided a newspaper server NPS which provides news information to the online advertisement output control server OAOCS, the shopping mall server SOPS, and the search portal server SPS.

The online advertisement output control system in accordance with the third embodiment of the present invention receives, from a user, an answer signal for the matching or non-matching between an advertisement posted in the middle of a text file, such a news article, and the content of the text file to change the corresponding advertisement according to the percentage of answering to the level of matching, or selects recommended words for the corresponding advertisement and classifies them, or receives recommended words to allow user to selectively enter them additionally, thus adjusting the corresponding advertisement so as to be posted in the text file having a precisely matching content. By this, it is possible to correct en error of an internet advertisement posting engine, such as Google, by a user's participation.

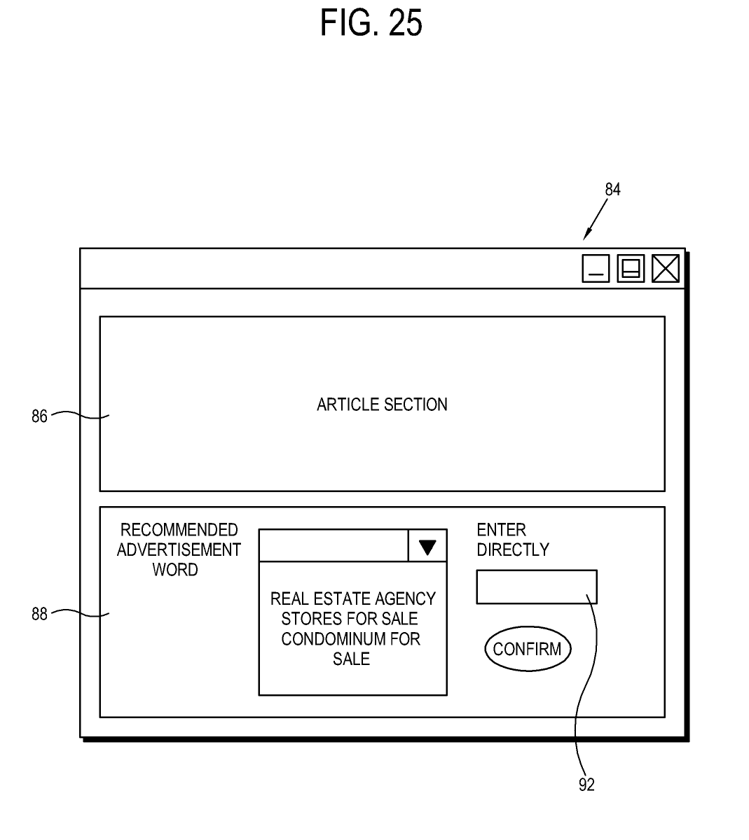

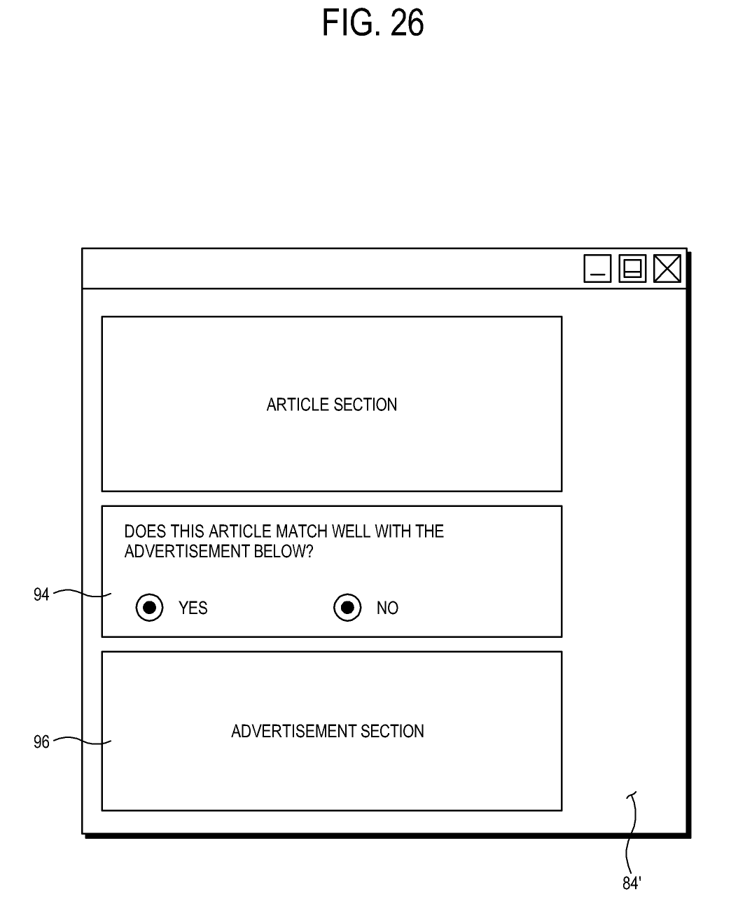

FIGS. 25 and 26 are views showing a state of posting an advertisement in an article through the online advertisement output control system in accordance with the third embodiment of the present invention.

Referring to these drawings, in general, as shown in FIG. 25, a text file 86, such as a news article, exists in the homepage 84 of a search portal server SPS or newspaper server NPS, and the click rate of users on such a news article is very high. Hence, in recent years, an advertisement is posted in the middle of a text file, such as a news article.

In the present invention, too, advertisement information is inserted in the middle of the text file 86, such as a news article. Further, in the present invention, a selection window 88 for recommended ad words 90 is provided below the text file 86, and an entry window 92 for directly entering advertisement information suitable to the corresponding text file or a recommended ad word is provided.

Therefore, a user views the content posted in the text file 86, such as a news article, and selects a recommended ad word most suitable to the corresponding content through the selection window and enters it, or directly enters a suitable advertisement, through the selection window 88. Such recommended word selection signal and advertisement entry information are applied to the online advertisement output control server OAOCS through the search portal server SPS or newspaper server NPS having the text file 86, such as a news article, posted therein. In case where more than a predetermined number of users recommends, the online advertisement output control server OAOCS posts one of the advertisements classified by recommended word in the corresponding text file 86 by taking the corresponding recommendation rate into account.

Moreover, as shown in FIG. 26, there is provided a survey window 94 below the corresponding text file for the advertisement posted in the text file in the homepage 84 of the search portal server SPS or newspaper server NPS, which executes a survey about whether the content of the corresponding text file and the advertisement inserted in the text file match well, and there are multiple advertisement link information and accumulated integrated rewards information 96 posted below the survey window 94.

Accordingly, in case where more than a predetermined number of users select a negative opinion about advertisement matching by considering the corresponding recommendation rate, the online advertisement output control server OAOCS changes the advertisement inserted in the corresponding text file.

Additionally, the online advertisement output control server OAOCS chooses users who answer the corresponding survey by lot and grants a given premium to winning users or grant discount points to them.

While the system of the present invention satisfies the advertiser's desire by posting an advertisement matching the content of a text file well in response to a survey, it maximizes the advertising effect by allowing multiple users who are aware of the system of the present invention to naturally look at whether the corresponding advertisement matches the content of the text file or not.

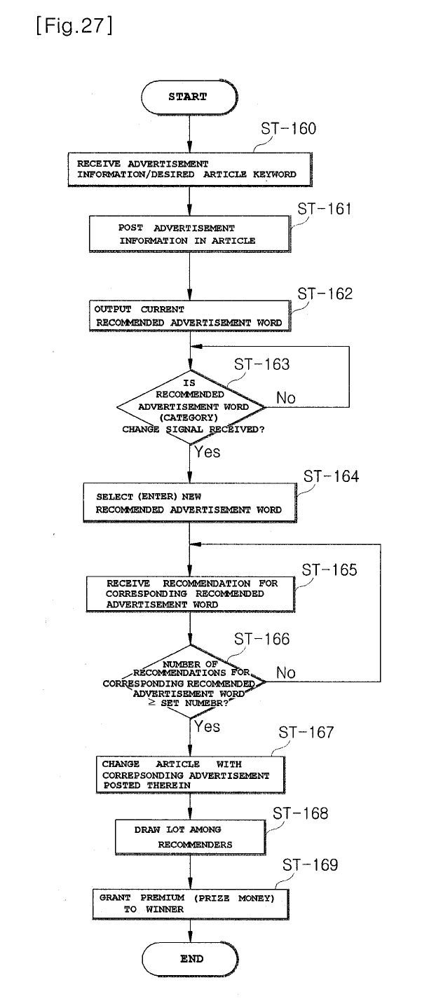

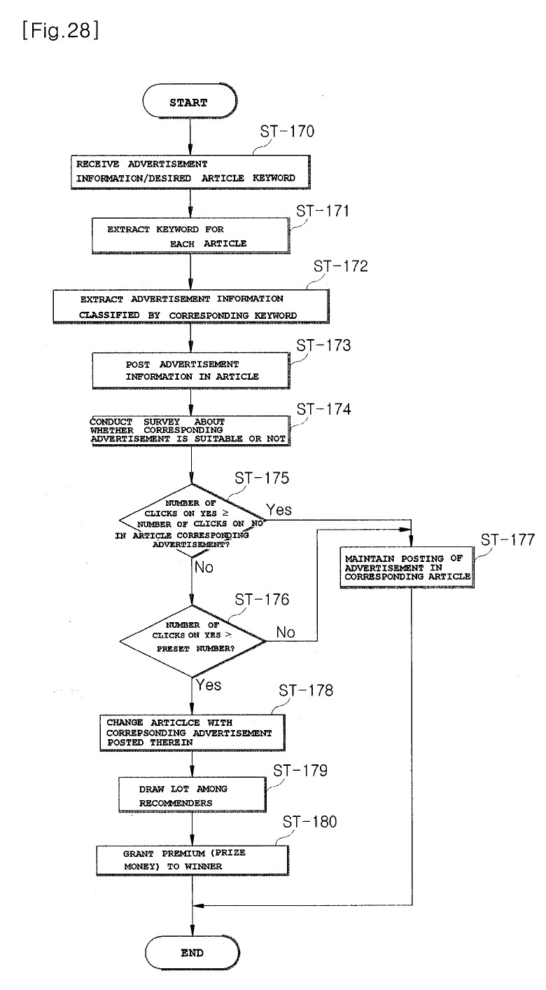

FIGS. 27 and 28 are flowcharts showing a signal flow of the online advertisement output control system in accordance with the third embodiment of the present invention.

First, referring to FIG. 27, the online advertisement output control server OAOCS receives various news articles or text files from the newspaper server NPS, classifies and registers them by attaching keywords matching the content of each of the articles, and transmits and post them to the search portal server SPS or the like.

In this state, the online advertisement output control server OAOCS receives advertisement information from the advertiser PCs B1˜Bn or the shopping mall server SOPS, and receives keywords of a desired article from the advertiser PCs or the shopping mall server (ST-160).

Then, the corresponding advertisement information is inserted in the middle of articles classified by the corresponding keywords (ST-161). That is, an advertisement posting field at the middle part of an article exposed to the newspaper server NPS and the search portal server SPS is blank, and the online advertisement output control server OAOCS sends and posts advertisement information in the corresponding ad posting field in a plug-in manner.

In this state, recommended words for classification of the corresponding advertisement are received from the user PCs A1˜An through a recommended ad word entry field provided below the corresponding article and registered (ST-165), and when more than a predetermined number of identical recommended ad word are received (ST-166), the online advertisement output control server OAOCS classifies the corresponding advertisement into the category of the recommended ad word.

In other words, the online advertisement output control server OAOCS changes the keyword classified and entered upon posting the advertisement into the corresponding recommended ad word (ST-167). If the recommended word of the corresponding advertisement does not match classified words of the article, the advertisement posted in the corresponding article is changed into another advertisement.

Next, the online advertisement output control server OAOCS draws a lot among the recommenders and grants a winner a given premium or prize money (ST-168 and ST-169).

Such a system of the present invention receives a recommendation for classified keywords for the advertisement included in the article by users' participation, and links the corresponding advertisement to the corresponding recommended word. Thus, in case where the corresponding advertisement is posted in other articles in the future, it is easily determined whether classified words of the article match the recommended word, thereby enabling it to post the advertisement in a mechanically well-matched article.

Referring to FIG. 28, the online advertisement output control server OAOCS receives various news articles or text files from the newspaper server NPS, classifies and registers them by attaching keywords matching the content of each of the articles, and transmits and post them to the search portal server SPS or the like.

In this state, the online advertisement output control server OAOCS receives advertisement information from the advertiser PCs B1˜Bn or the shopping mall server SOPS, and receives keywords of a desired article from the advertiser PCs or the shopping mall server (ST-170).

Then, the corresponding advertisement information is inserted in the middle of articles classified by the corresponding keywords.

The online advertisement output control server OAOCS receives a survey about whether the content of the text of the corresponding article matches the posted advertisement below the corresponding article (ST-174). That is, the survey information is received by the online advertisement output control server OAOCS through the newspaper server NPS or the search portal server SPS that has the article posted therein according to a user's click.

Then, the online advertisement output control server OAOCS decides whether the number of clicks on ‘Yes’ exceeds the number of clicks on ‘No’ in the survey about matching between the article and the corresponding advertisement. If the number of clicks on ‘Yes’ exceeds the number of clicks on ‘No’ (ST-175), the advertisement in the corresponding article is maintained. On the contrary, if the number of clicks on ‘No’ exceeds the number of clicks on ‘Yes’ in the survey, this means that the corresponding article and the advertisement do not match with each other. Hence, the online advertisement output control server OAOCS determines whether the number of clicks on ‘No’ exceeds a preset number (ST-176). If so, a lot of users, more than a predetermined number, think that the corresponding article and the advertisement do not match with each other, and thus the online advertisement output control server OAOCS changes the advertisement in the corresponding article (st-178).

If the number of clicks on ‘No’ does not exceed a preset number, the online advertisement output control server OAOCS maintains the posting of the corresponding advertisement (ST-177). Then, the online advertisement output control server draws a lot among the corresponding recommenders, and grants a given premium or prize money to a winner (ST-179 and ST-180).

It is to be understood that the online advertisement output control system and method in accordance with the present invention are not limited to the above-mentioned embodiments and that various changes and modifications may be made without departing from the technical scope of the invention.

1-13. (canceled)

14. An online advertisement output control method, comprising the steps of:
at an online advertisement output control server, receiving brand icon issuing information and brand icon information transmitted from advertiser PCs, and receiving and registering search keyword information desired by the corresponding advertiser;
at the online advertisement output control server, transmitting and registering the corresponding search keyword and brand icon information to a search portal server or shopping mall server;
at the search portal server or the shopping mall server, receiving the corresponding search keyword information and brand icon information and registering them in conjunction with a pre-established search engine;
at the online advertisement output control server, receiving a user's keyword search word from the search portal server or the shopping mall server, and determining whether the corresponding keyword matches a search word preset by the advertiser;
at the online advertisement output control server, if the search word entered by the user matches the search word preset by the advertiser, giving the corresponding user the brand icon;
outputting detailed information of the product linked to the corresponding brand icon as a pop-up window in the form of an advertisement;
at the online advertisement output control server, carrying out reduction of the face value for the brand icon according to the passage of time;
at the online advertisement output control server, retrieving the unique number of the brand icon and extracting a discountable amount of the corresponding brand icon; and
performing a discount process on the corresponding product.

15. The method of claim 14, wherein the advertiser is able to issue the corresponding brand icon and output it to the screen only when a specific search keyword among search keywords of a search portal or shopping mall is entered.

16. The method of claim 14, wherein the step of extracting the discountable amount of the corresponding brand icon is replaced with the steps of:
designating specific stocks; and
variably calculating the discount value of the corresponding brand icon so as to be in inverse proportion to the price of the corresponding stocks.

17-23. (canceled)

24. An online advertisement output control system, comprising:
user PCs having a communication module, such as a modem, and a browser embedded therein so as to access the main screen of a shopping mall or search portal and click on a search result through searching for shopping or through searching of specific information, to output corresponding search result information and star's registration information on the screen;
advertiser terminals which provide advertising payment costs for each advertiser or each sales product of an advertiser, and also perform the viewing and registration of advertisement information in order to set a desired site or product advertising data and star registration information in an online advertisement output control server;
the online advertisement output control server which processes the settlement of per-click advertising costs for advertisement information registered by a corresponding advertiser in real time, calculates accumulated integrated rewards by advertiser site or product category, displays the calculated accumulated integrated rewards on the screen of a shopping mall, a search portal, or an affiliated store payment terminal, performs discount processing and purchase payment based on the accumulated integrated rewards, and registers the transmitted star information in the shopping mall or search portal server;
a shopping mall server and a search portal server which are linked to the online advertisement output control server to upload advertisement information to the online advertisement output control server, register marketing advertisement information, receive advertising costs settlement information, and post star registration information in the homepage; and
a star management server, which transmits and registers star image and moving image information, new release information, star homepage information, etc. to the online advertisement output control server, and is given a per-click payment amount of the corresponding information.

25. The system of claim 24, wherein link information of the shopping mall companies linked to search result output windows and a star registration image are outputted in the homepage of the search portal server.

26. The system of claim 25, wherein when the star image is clicked, the homepage information of the advertisement companies linked to the star image is set in the search portal server for outputting thereof.

27. The system of claim 24, wherein the online advertisement output control server manages portrait rights for the corresponding star registration images through reception and transmission of infatuation from/to the star management server, manages the duration of use of the portrait rights and per-click fees for each of the corresponding registration images, and transmits and posts a star image in the homepage of a corresponding linked company in a plug-in manner in case of image registration, and the linked company processes the corresponding star image and uses it after gaining approval through the online advertisement output control server or the star management server.

28. The system of claim 24, wherein the star registration information includes moving image/image information, new release information, star schedule information, and homepage information.

29-34. (canceled)

35. An online advertisement output control system, comprising:
user PCs having a communication module, such as a modem, and a browser embedded therein so as to access the main screen of a shopping mall or search portal and enter a selection signal about whether an advertisement posted in a news article or various text files stored in the server are matched or not or enter a recommended ad word;
advertiser terminals which provide advertising payment costs for each advertiser or each sales product of an advertiser, and perform the viewing and registration of advertisement information in order to set a desired site or product advertising data in an online advertisement output control server;
the online advertisement output control server which processes the settlement of per-click advertising costs for advertisement information registered by a corresponding advertiser in real time, calculates accumulated integrated rewards by advertiser site or product category, displays the calculated accumulated integrated rewards on the screen of a shopping mall, a search portal, or an affiliated store payment terminal, performs discount processing and price payment based on the accumulated integrated rewards, posts the corresponding advertisement in various text files, such as a news article, of a search portal or shopping mall, and receives the matching or non-matching of the advertisement and recommended word data for advertisement from the user PCs to change the posted advertisement;
a shopping mall server and a search portal server, which access to a variety of websites, such as shopping malls, search portals, respective e-commerce malls, personal blogs, etc., having advertisement information and product information posted therein to output the corresponding advertisement information in the middle of the text files, are linked to the online advertisement output control server to upload advertisement information to the online advertisement output control server, register marketing advertisement information, receive advertising costs settlement information, and post text files, such as news information, in the homepage; and
a newspaper server which provides news information to the online advertisement output control server, the shopping mall server, and the search portal server.

36. The system of claim 35, wherein the online advertisement output control server changes the advertisement inserted in the corresponding text file if more than a predetermined number of users select a negative opinion on the advertisement matching by taking the corresponding recommendation rate into account.

37. The system of claim 35, wherein a text file such as news articles exists in the homepage of the search portal server or newspaper server, the advertisement information is inserted in the middle of the text file, a selection window for the recommended advertisement word is prepared below the text file, and an entry window for directly entering advertisement information suitable to the corresponding text file or the recommended ad word is provided.

38. The system of claim 35, wherein a survey window is provided below the corresponding text file for the advertisement posted in the text file in the homepage of the search portal server or newspaper server, which executes a survey about whether the content of the corresponding text file and the advertisement inserted in the text file match well.

39-40. (canceled)
